(19) United States
(12) Patent Application Publication
(10) Pub. No.: US 2022/0341617 A1
(43) Pub. Date: Oct. 27, 2022

(54) Methods, Systems and Computer Program Products for Measuring, Verifying and Controlling the Energy Efficiency of Residential and Light Commercial Heating, Ventilation and Air-Conditioning (HVAC) Systems

(71) Applicant: Truveon Corp., Mountain View, CA (US)

(72) Inventors: Jan-Dieter Spalink, Mountain View, CA (US); Karin Spalink, Mountain View, CA (US); George O'Keefe, Durham, NC (US)

(21) Appl. No.: 17/723,542

(22) Filed: Apr. 19, 2022

Related U.S. Application Data
(60) Provisional application No. 63/178,237, filed on Apr. 22, 2021.

(51) Int. Cl. F24F 11/63; G05B 19/042

(52) U.S. Cl. CPC F24F 11/63; G05B 19/042; G05B 2219/2614

(57) ABSTRACT

Methods for assessing the overall energy efficiency of a building are provided including receiving data related to the plurality of HVAC systems from at one or more of the plurality of MRACs. The data related to the plurality of HVAC systems is associated with physical, structural and thermal properties (“properties”) of the building. The data related to the plurality of HVAC systems is organized by defining categories of relevant data related to the plurality of HVAC systems. The categories of relevant data are defined by one or more properties and/or operational characteristics of the building. The defined categories of relevant data are associated with a corresponding one or more of the plurality of MRACs. Each MRAC receives data that satisfy data in the defined categories associated therewith. A hierarchy is created among the plurality of MRACs such that each increasing level of the hierarchy provides a more detailed assessment of the overall level of energy efficiency for buildings in the defined category of relevant data.

### CLAIM OF PRIORITY

The present application claims the benefit of and priority to U.S. Provisional Application No. 63/178,237, filed on Apr. 22, 2021, entitled Methods, Systems and Computer Program Product for Measuring, Verifying and Controlling the Energy Efficiency of Residential and Light Commercial Heating, Ventilation and Air-Conditioning (HVAC) Systems, the entire contents of which is hereby incorporated herein by reference as if set forth in its entirety.

### FIELD

The present inventive concept relates generally to energy efficiency and, more particularly, to methods and related computer programs for measuring, verifying and controlling energy efficiency in HVAC systems.

### BACKGROUND

Intense competition forces home builders to optimize their products quite carefully for each segment of their local target markets. Almost all home buyers in most market segments are looking for the biggest home they can buy—and for the lowest price, since that is the only factor that determines their monthly mortgage payments. The fraction of home buyers who are willing to pay a premium for a better performing, more energy efficient home is minuscule in almost all areas of the country. Depending on the construction of the building envelope, these homes therefore may or may not shield the occupant from negative infiltration of outdoor pollutants, for example, pollen, dust, humidity and the like. However, occupants also want to be comfortable and free from any indoor pollutants that may cause, for example, health problems. Buildings having superior structural integrity may have negligible infiltration of outdoor pollutants, but may not have sufficient means of controlling ventilation to dilute indoor pollutants. Residential builders in particular have been unable to reconcile these two opposing requirements and, therefore, typically shy away from building tight, superior structures and the use of more advanced climate control systems that would alleviate the shortfalls of the corresponding indoor environment. These residential builders subsequently expect homeowners to accept, for example, leaky, uncomfortable, unhealthy, and less energy-efficient buildings.

As a result, homeowners may experience unnecessary expenditures for expensive energy that is needed to control the climate/environment in the home. At times, homeowners may also experience personal discomfort, health problems, and/or the deterioration of some of their most valuable assets, i.e., the structure of the building itself, and/or many of its contents, such as hardwood floors, trim, furnishings, collectibles, artwork, books, furniture, musical instruments, and the like.

### SUMMARY

Some embodiments of the present inventive concept provide methods for assessing energy efficiency of an HVAC system in a system including a plurality of model reference adaptive controllers (MRACs) in communication with a plurality of local reference models positioned at one of each of a corresponding plurality of HVAC systems. The method includes receiving data related to the plurality of HVAC systems at one or more of the plurality of MRACs, wherein the data related to the plurality of HVAC systems is associated with physical properties of a building associated with one of the plurality of buildings, a location of the building, an operational status of the building, a geographic orientation of the building, an elevation of the building, performance of a building envelope, occupants of the building and/or climate inside or outside the building; organizing the data related to the plurality of HVAC systems by defining categories of relevant data related to the plurality of HVAC systems, the categories of relevant data being defined by one or more of the physical properties of the building, the location of the building, the operational status of the building, the geographic orientation of the building, the elevation of the building, the performance of a building envelope, the occupants of the building and/or the climate inside or outside the building; associating the defined categories of relevant data with a corresponding one or more of the plurality of MRACs, each of the plurality of MRACs receiving data related to the plurality of HVAC systems that satisfy data in the defined categories associated therewith; and creating a hierarchy among the plurality of MRACs using the defined categories associated therewith such that each increasing level of the hierarchy provides a more detailed assessment of energy efficiency for buildings in the defined category of relevant data associated with each particular one of the plurality of MRACs. At least one of the receiving, organizing, associating and creating are performed by at least one processor.

In further embodiments, the method may further include evaluating received data related to the plurality of HVAC systems within each of the defined categories; defining thresholds based on the evaluated data, the thresholds indicating consistent values for the data based on the received data from the plurality of HVAC systems; and identifying buildings among the plurality of HVAC systems providing data that falls outside the defined thresholds.

In still further embodiments, the method may further include identifying causation at the buildings identified as providing data that falls outside the defined threshold.

In some embodiments, the method may further include grouping two or more buildings of the plurality of HVAC systems to define one or more cohorts of buildings, wherein each of the cohorts includes two or more buildings that have one or more similar physical properties. Creating the hierarchy among the plurality of MRACs may further include creating the hierarchy using the one or more cohorts.

In further embodiments, a building may belong to more than one cohort.

In still further embodiments, the data associated with the one or more buildings may include a specific geographic location; an orientation of outside walls of the building home facing either north, south, or any number of degrees in between; a number of levels of the building; an attached or detached garage; details on pitches of roofs on various parts of the building; number, size and orientation of dormers; various degrees of roof overhang; various numbers, locations, and sizes of windows that have various levels of solar heat gain coefficients (“SHG”) and/or various levels of air leakage; various numbers, locations, and sizes of outside doors that have various levels of solar heat gain coefficients (“SHG”) and/or various levels of air leakage; entire sets or subsets of foundations consisting of concrete slabs, crawlspaces or full basements constructed with a range of building materials (“foundations”); entire sets or subsets of foundations, walls, ceilings, floors, attics, and roofs with different levels of thermal insulation; entire sets or subsets of foundations, walls, ceilings, floors, attics and roofs with different levels of infiltration; entire sets or subsets of foundations, walls, ceilings, floors, attics, and roofs with different levels of thermal insulation; and/or entire sets or subsets of walls, ceilings, floors, attics and roofs with different amounts of thermal mass; details with respect to occupants of the building.

Related computer and non-transitory machine readable embodiments are also provided herein.

### BRIEF DESCRIPTION OF THE DRAWINGS

FIGS. 1A and 1B are block diagrams illustrating data processing systems according to some embodiments of the present invention.

FIG. 2 is a block diagram illustrating an exemplary system according to some embodiments of the present invention.

FIG. 3 is a block diagram illustrating control systems according to some embodiments of the present invention.

FIG. 4 is a block diagram illustrating a local reference model in the system of FIG. 3 in accordance with some embodiments of the present inventive concept.

FIG. 5 is a block diagram illustrating communication of data in the system of FIG. 3 in accordance with some embodiments of the present inventive concept.

FIG. 6 is a block diagram illustrating a cloud repository in the system of FIG. 3 in accordance with some embodiments of the present inventive concept.

FIG. 7 is a block diagram illustrating expansion of the system of FIG. 3 to more than one HVAC system in accordance with some embodiments of the present inventive concept.

FIG. 8 is a block diagram illustrating a system including a plurality of MRACs and HVAC systems in accordance with some embodiments of the present inventive concept.

FIG. 9 is a block diagram illustrating communications between MRACs and HVAC systems in accordance with some embodiments of the present inventive concept.

FIG. 10 is a block diagram illustrating the use of hierarchies in accordance with some embodiments of the present inventive concept.

FIG. 11 is a block diagram illustrating hierarchies and cohorts in accordance with some embodiments of the present inventive concept.

FIG. 12 is a block diagram illustrating an example using hierarchies and cohorts in accordance with some embodiments of the present inventive concept.

FIG. 13 is a flowchart illustrating various embodiments of the present inventive concept.

FIG. 14 is a block diagram including a data processor that may be included in any component of the system in accordance with various embodiments of the present inventive concept.

### DETAILED DESCRIPTION

The inventive concept now will be described more fully hereinafter with reference to the accompanying drawings, in which illustrative embodiments of the inventive concept are shown. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art. Like numbers refer to like elements throughout. As used herein, the term “and/or” includes any and all combinations of one or more of the associated listed items. Similarly, as used herein, the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Reference will now be made in detail in various and alternative example embodiments and to the accompanying figures. Each example embodiment is provided by way of explanation, and not as a limitation. It will be apparent to those skilled in the art that modifications and variations can be made without departing from the scope or spirit of the disclosure and claims. For instance, features illustrated or described as part of one embodiment may be used in connection with another embodiment to yield a still further embodiment. Thus, it is intended that the present disclosure includes modifications and variations that come within the scope of the appended claims and their equivalents.

The overall energy efficiency of a building depends on both the energy efficiency of a heating, ventilation and air-conditioning (HVAC) system and the energy efficiency of the envelope of the building where it is installed, consisting of constructive elements such as roofs, walls, windows, doors, for example. In order to optimize the overall energy efficiency of a building, HVAC systems generally need to be designed such that they compensate for any thermal performance shortfalls of the building envelope, which are customarily expressed as heating and cooling loads. The design and the system capacity of HVAC systems generally needs to take these heating and cooling loads into account, resulting in an indoor climate that is considered comfortable by the occupants of the building. In other words, the properties of the HVAC system and of the building envelope generally need to be matched as closely as possible for this purpose. Thus, embodiments of the present inventive concept considers the capacity and the energy efficiency of an HVAC system in the context of the physical and thermal properties of a building.

The fraction of home buyers who are willing to pay a premium for a better performing, more energy efficient home is minuscule in almost all areas of the country. Due to the construction of the building envelope, these buildings therefore may or may not shield the occupant from negative infiltration of outdoor pollutants, for example, pollen, dust, humidity and the like. However, occupants also want to be comfortable and free from any indoor pollutants that may cause, for example, health problems. Buildings having superior structural integrity may have negligible infiltration of outdoor pollutants, but may not have sufficient means of controlling ventilation to dilute indoor pollutants. Residential builders in particular have been unable to reconcile these two opposing requirements and, therefore, typically shy away from building tight, superior structures and the use of more advanced climate control systems that would alleviate the shortfalls of the corresponding indoor environment. These residential builders subsequently expect homeowners to accept, for example, leaky, uncomfortable, unhealthy, and less energy-efficient buildings.

As a result, homeowners may experience unnecessary expenditures for expensive energy that is needed to control the climate/environment in the home. At times, homeowners may also experience personal discomfort, health problems, and/or the deterioration of some of their most valuable assets, i.e., the structure of the building itself, and/or many of its contents, such as hardwood floors, trim, furnishings, collectibles, artwork, books, furniture, musical instruments, and the like.

Accordingly, some embodiments of the present inventive concept provide methods and related computer programs that measure, verify and control the energy efficiency in residential structures, and, by implication, the energy efficiency of HVAC systems in particular that have been installed in these structures, such as a detached single family home, for example (“homes”), as a function of, among other variables and given parameters, the physical and mechanical properties of building envelopes, the local climate, the quality of the indoor climate, the thermal comfort provided by these structures, and the cost of electrical power and/or other forms of energy available at the location of these homes.

As used herein, “energy efficiency” refers to a degree to which a primary energy provided to a home is converted by various technical or procedural means at that home, such as an HVAC system, into some other (secondary) form of energy. For example, in an HVAC system, electric energy (measured in kilowatts (kWh)) might be converted into thermal energy (measured in British Thermal Units, (BTUs)). Embodiments of the present inventive concept specifically cover the degree to which a primary energy in the form of electrical energy, or geothermal energy, or solar energy, or wind energy, or natural gas, for example, is converted into the energy content of another thermal or mechanical process that has a specific, quantifiable outcome, such as, but not limited to, increasing or reducing the humidity content of the air in a home, the amount of outside air introduced into the home by way of ventilation or other means, the reduction of acoustical noise transmitted from outside the home into the indoor environment, or the quality of the air in a home, or the level of thermal comfort in a home, or the degree to which it translates into a productive occupational indoor environment, as well as the amount of energy that is required to manage and control any and all of these and similar transformations, for example.

Although embodiments of the present inventive concept are discussed below with respect to the principle of model reference adaptive control (MRAC), embodiments of the present inventive concept are not limited to this specific example. Embodiments discussed herein can be used in combination with any reference model without departing from the scope of the present inventive concept. In particular, any details provided in the current disclosure about the functional implementation of the reference models themselves (the “M”) that are used in these MRACs (i.e., they should be a black box) are provided as examples only and thus do not limit embodiments of the present inventive concept in any way by how these reference models might be implemented. Similarly, the type and/or functionality of equipment, such as some implementation of a heating, ventilation and air conditioning (HVAC) system that is being used to control certain parameters within the home is not limited to an HVAC system, but can be provided by any applicable system. Thus, embodiments discussed herein are provided for example only and should not be limited by the specific examples herein.

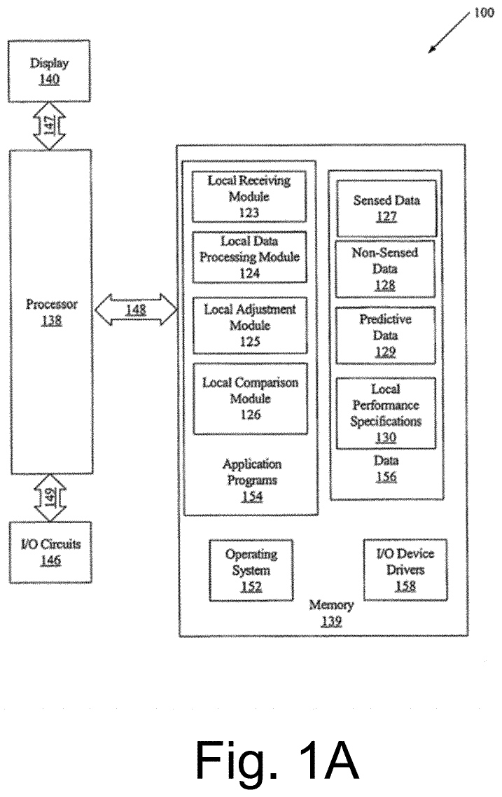

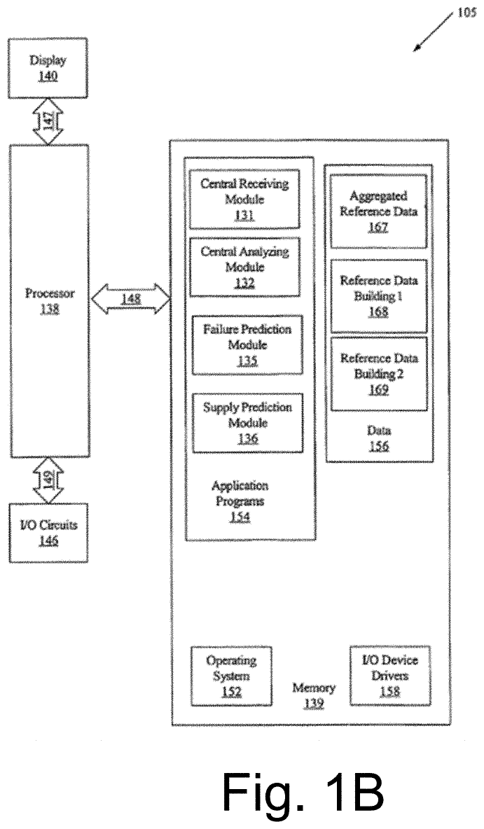

The principle of model reference adaptive control (MRAC) is discussed, for example, in commonly assigned U.S. Pat. No. 7,839,275 entitled Methods, Systems and Computer Program Products for Controlling a Climate in a Building, the content of which is hereby incorporated herein by reference as if set forth in its entirety. Details with respect to the model reference adaptive control approach are discussed in, for example, Robust Adaptive Control to P. A. Ioannou et al. (Prentice Hall, 1996, p. 314), the disclosure of which is also hereby incorporated herein by reference as if set forth in its entirety. As will be discussed further below, some embodiments of the present inventive concept use one or more instances of MRAC systems. An example MRAC system will now be discussed with respect to FIGS. 1A through 3.

Referring to FIGS. 1A through 3, embodiments of the present inventive concept directed to methods, systems and computer program products for measuring, verifying and controlling the energy efficient operation of a building will now be discussed. As discussed herein, some embodiments of the present invention involve improving the performance of indoor climate control systems in a building, which may be discussed herein as “adjusting at least one parameter associated with the climate.” The performance of indoor climate control systems may be improved by, for example, managing the effects of infiltration of, for example, pollen, dust, humidity and the like on the indoor climate, controlling parameters that contribute to thermal comfort of the occupants of the building, controlling parameters that contribute to indoor air quality and managing the performance and operation of mechanical/electrical systems involved in controlling the indoor climate of the building. These things can be managed and/or controlled at a local level, i.e. at the building, or at a central location, i.e., at a central processor that is coupled to a plurality of buildings, as will be discussed further herein. As used herein, “coupled” refers to mechanically, electrically, wirelessly and/or optically coupled.

As used herein, “thermal comfort” refers to an occupant's comfort in the associated building climate. In particular, the quality of the building climate can have a significant impact on the comfort, health, and overall sense of well-being of building occupants. The occupants' sense of thermal comfort at any particular point in time is largely a function of the temperature, humidity and air circulation of their immediate environment, and it is influenced by personal factors, such as their age, sex, level metabolism, amount of clothing, and the physical activity in which they are currently engaged.

Occupants can adapt to changes in their thermal environments. The adaptation process involves physiological, behavioral and psychological mechanisms. Occupants can adjust their behavior, by adding or removing clothes, or by moving to a different location. Occupants can also make changes to their environment, for example, by adjusting the settings of their climate control system (such as, but not limited to a traditional thermostat, a programmable thermostat, or a programmable communicating thermostat, for example) or by opening windows. Alternatively, occupants can change their expectations about the quality of an occupant's thermal environment. Furthermore, and over an extended time frame, their body is also able to acclimatize by adapting its physiological mechanisms to different climate regimens.

In some embodiments of the present invention a plurality of sensors are positioned inside and/or outside a building. These sensors are configured to collect sensed data. As used herein, “sensed data” refers to any data that may be detected or sensed by the sensors positioned inside and/or outside the building, for example, weather conditions, temperature, pressure, humidity, air flow and the like. Some embodiments of the present invention also use non-sensed data. For example, the non-sensed data may include type of materials used to construct the building, methods of construction used to construct the building, static information about the occupants of the building, such as gender or contact telephone number, and the like. Both “sensed” and “non-sensed” data will be referred to collectively herein as “reference data.”

As used herein, “reference data” refers to recorded and persistently stored metrics and time series of metrics, which may include but are not limited to information about building structures, indoor climates, mechanical equipment, control systems, and/or the local weather, either in analog or digital format, and at various levels of resolution and accuracy. In some embodiments of the present invention, the term “persistently stored” may be used to indicate explicitly that the involved data are not just buffered in some registers for certain time periods that are required for some related processing operation, only to be discarded after the processing operation has been concluded, but are actually archived, so that they can be retrieved for future reference. Reference data may also include metrics about the building occupants, such as their number at a particular location within the building at any given point in time, their age, gender, race, marital status, level of education, occupation, income, financial assets, commuting times, number and age of children, number and age of dependents and relatives living in the house, temporary help and household employees, number and type of pets, smoking habits, eating and cooking habits, sleeping habits, personal hygiene regimens, physical exercise habits, recreational habits, house cleaning habits, use of household appliances, and other or similar socio-economic or lifestyle related variables.

As used herein, “predictive data” refers to the result of one or more processing operations involving reference data, as well as mathematical algorithms, time series analysis, correlation, and the like, as will be discussed further below.

As used herein, “climate” refers to temperature, humidity, air pressure, air quality, ventilation, air circulation, and the like. Thus, climate may refer to more than just temperature and, in particular, climate may refer to any aspect of the indoor environment. As will be discussed herein, the reference data may be processed and analyzed at a local level to determine the thermal comfort of the occupants of the building individually and collectively, the energy efficiency/conservation associated with the building, the indoor air quality of the building, how the mechanical/electrical or climate control equipment in the building is performing and/or how the climate is affecting the structure itself and/or the contents of the structure. Once this reference data is obtained and processed, one or more parameters associated with the climate may be adjusted based on the reference data. For example, a comparison of the actual sensed data in the building with local performance metrics and/or specifications for the building may indicate that the climate control system in the building is not meeting certain of the performance metrics and/or specifications. Thus, one or more parameters of the climate control system may be adjusted to bring the actual performance of the climate control system in line with the local performance metrics and/or specifications.

As will be discussed further herein, some embodiments of the present invention begin with the planning phase of the construction of the building or building envelope. As used herein, “building envelope” refers to the entire outer shell of the building, i.e., walls, roof, windows and doors and the layers of building materials and components associated therewith. However, it will be understood that control systems according to embodiments of the present invention can be implemented in new or existing structures without departing from the scope of the present invention. Furthermore, even the most advanced envelope construction, by itself, may not achieve a certain level of indoor air quality and thermal comfort without a climate control system that regulates temperature, humidity, air quality, pressure, ventilation, and the like as provided by climate control systems according to some embodiments of the present invention.

Referring first to FIG. 1A, an exemplary local data processing system 100, one or more of which may be included in a building according to some embodiments of the present invention will be discussed. As illustrated, the data processing system 100 includes a display 140, a processor 138, a memory 139 and input/output circuits 146. The data processing system 100 may be incorporated in, for example, a personal computer, server, router or the like. The processor 138 communicates with the memory 139 via an address/data bus 148, communicates with the input/output circuits 146 via an address/data bus 149 and communicates with the display via a connection 147. The input/output circuits 146 can be used to transfer information between the memory 139 and another computer system or a network using, for example, an Internet Protocol (IP) connection. These components may be conventional components, such as those used in many conventional data processing systems, which may be configured to operate as described herein.

In particular, the processor 138 can be any commercially available or custom microprocessor, microcontroller, digital signal processor or the like. The memory 139 may include any memory devices containing the software and data used to implement the functionality circuits or modules used in accordance with embodiments of the present invention. The memory 139 can include, but is not limited to, the following types of devices: cache, ROM, PROM, EPROM, EEPROM, flash memory, SRAM, DRAM and magnetic disk. In some embodiments of the present invention, the memory 139 may be a content addressable memory (CAM).

As further illustrated in FIG. 1A, the memory 139 may include several categories of software and data used in the data processing system 100: an operating system 152; application programs 154; input/output device drivers 158; and data 156. As will be appreciated by those of skill in the art, the operating system 152 may be any operating system suitable for use with a data processing system, such as OS/2, AIX or zOS from International Business Machines Corporation, Armonk, N.Y., Windows95, Windows98, Windows2000 or WindowsXP from Microsoft Corporation, Redmond, Wash., Unix or Linux, or Mac OSX-n from Apple. The input/output device drivers 158 typically include software routines accessed through the operating system 152 by the application programs 154 to communicate with devices such as the input/output circuits 146 and certain memory 136 components. The application programs 154 are illustrative of the programs that implement the various features of the circuits and modules according to some embodiments of the present invention. Finally, the data 156 represents the static and dynamic data used by the application programs 154, the operating system 152, the input/output device drivers 158, and other software programs that may reside in the memory 136. As illustrated in FIG. 1A, the data 156 may include sensed data 127, non-sensed data 128, predictive data 129 and/or local performance metrics and/or specifications 130 for use by the circuits and modules of the application programs 154 according to some embodiments of the present invention as discussed further herein.

As further illustrated in FIG. 1A, the application programs 154 include a local receiving module 123, a local data processing module 124, a local adjustment module 125 and a local comparison module 126. While the present invention is illustrated with reference to the local receiving module 123, the local data processing module 124, the local adjustment module 125 and the local comparison module 126 being application programs in FIG. 1A, as will be appreciated by those of skill in the art, other configurations fall within the scope of the present invention. For example, rather than being application programs 154, the local receiving module 123, the local data processing module 124, the local adjustment module 125 and the local comparison module 126 may also be incorporated into the operating system 152 or other such logical division of the data processing system 100, such as dynamic linked library code. Furthermore, the local receiving module 123, the local data processing module 124, the local adjustment module 125 and the local comparison module 126 are illustrated in a single data processing system, as will be appreciated by those of skill in the art, such functionality may be distributed across one or more data processing systems. Thus, the present invention should not be construed as limited to the configuration illustrated in FIG. 1A, but may be provided by other arrangements and/or divisions of functions between data processing systems. For example, although FIG. 1A is illustrated as having multiple modules, the modules may be combined into three or less or more modules may be added without departing from the scope of the present invention.

As discussed above, the local data processing system 100 may be provided in a building, for example, a residence, in accordance with some embodiments of the present invention. The local receiving module 123 may be coupled to one or more sensors positioned inside and/or outside the building. Typically, hundreds of sensors will be positioned inside and/or outside the building to collect sensed data associated with weather conditions, indoor climate of the building, occupants and the like. For example, in some embodiments of the present invention, one or more sensors may be configured to obtain pressure differentials between all major outside wall surfaces and one or more enclosures or compartments on the inside of the building. These pressure differentials may be used to maintain a predetermined pressure differential between the interior compartments and the exterior of the building as will be discussed further below. Thus, the local receiving module 123 may be configured to receive the sensed data 127 collected by the sensors positioned inside and/or outside the building.

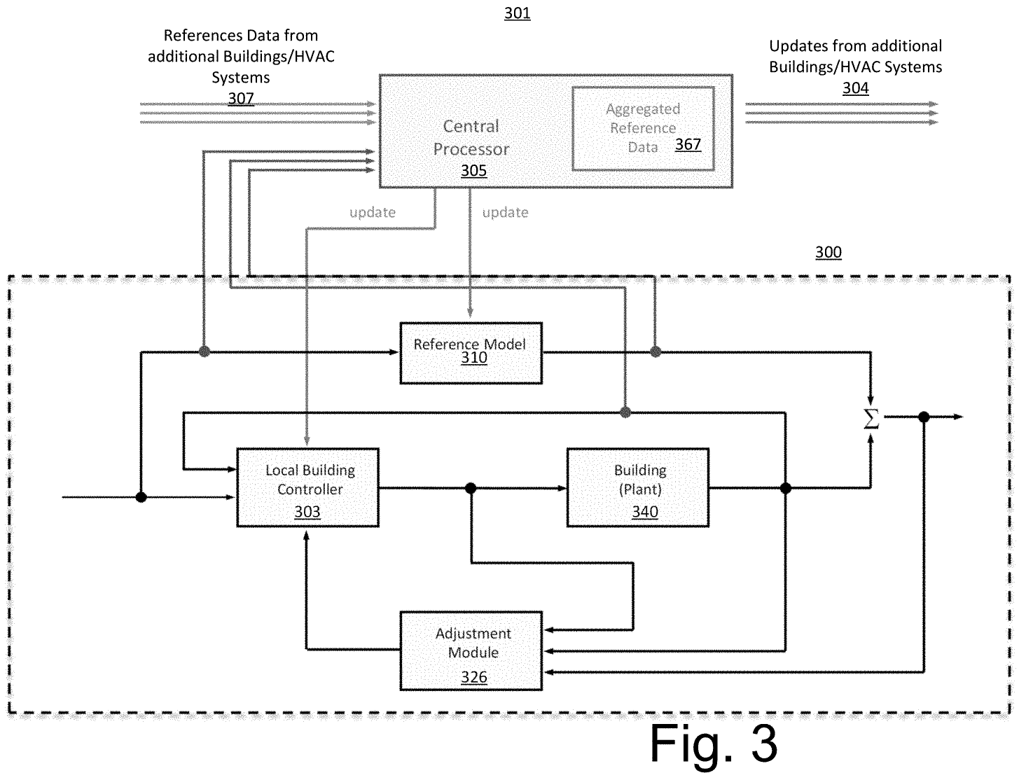

The comparison module 126 may be configured to compare the received sensed data with corresponding predictive data 129 associated with the climate in the building, weather outside the building and/or occupants of the building. The predictive data 129 may be associated with a reference model for the building, which will be discussed further below with respect to FIG. 3. The local adjustment module 125 may be configured to adjust one or more parameters associated with the climate of the building based on a result of the comparison of the received sensed data 127 and the predictive data 129. For example, if the predictive data 129 indicates that the building should cool down in 2 minutes and the sensor data 127 indicates that the cool down process is taking longer than two minutes, certain parameters may be adjusted to cool the building down faster. For example, the vents in the building may be opened wider and the air flow rate may be increased.

As used herein, “parameters associated with the climate” may refer, but are not limited, to air temperature, temperature of nearby surfaces, relative humidity, air flow (circulation), radiant surface temperatures (walls, floors, ceilings, windows), air circulation patterns (supply and return register operation, damper positions), air exchange rate, ventilation rate, combustion byproducts (SO_{X}, NO_{X}, CO, CO₂, and the like), dust loads (PPM 2.5, PPM 10), air flow (draft) in open chimneys, room pressure differentials, air filter loads (air flow through filters) and the like. It will be understood that the parameters set out herein are provided for exemplary purposes only and, therefore, embodiments of the present invention should not be limited to these examples. Any parameter associated with climate control may be adjusted in accordance with some embodiments of the present invention without departing from the scope of the invention.

The comparison module 126 may be further configured to compare the received sensed data 127 with local performance metrics and/or specifications 130 associated with the building. For example, the building may have certain performance metrics and/or specifications associated with the building, which may be used to regulate the climate in the building. The local adjustment module 125 may be further configured to adjust one or more parameters associated with the climate based on a result of the comparison of the received sensed data 127 and the local performance metrics and/or specifications 130 associated with the building. For example, the local performance specification 130 may indicate a certain energy efficiency and the sensed data 127 may indicate that the building is not achieving the specified energy efficiency. Thus, the local adjustment module 125 may be configured to adjust one or more parameters to bring the energy efficiency in line with the performance metrics and/or specifications 130.

Referring now to FIG. 1B, an exemplary central data processing system 105 according to some embodiments of the present invention will be discussed. It will be understood that like numbered elements of FIG. 1A are substantially similar to like numbered elements of FIG. 1B and, therefore, the details with respect to these elements will not be discussed further herein. In particular, only the application programs 154 and the data 156 of FIG. 1B will be discussed in detail. As illustrated in FIG. 1B, the data 156 may include stored aggregated reference data 167, reference data associated with a first building 168 and reference data associated with a second building 169 for use by the circuits and modules of the application programs 154 according to some embodiments of the present invention as discussed further herein. It will be understood that, although only reference data associated with two buildings is illustrated, embodiments of the present invention are not limited to this configuration. As discussed above, three or more buildings may be coupled to the central server and, in fact, the more buildings used, the more accurate the reference model may be.

As further illustrated in FIG. 1B, the application programs 154 include a central receiving module 131, a central analyzing module 132, a failure prediction module 135 and a supply prediction module 136. While the present invention is illustrated with reference to the central receiving module 131, the central analyzing module 132, the failure prediction module 135 and the supply prediction module 136 being application programs in FIG. 1B, as will be appreciated by those of skill in the art, other configurations fall within the scope of the present invention. For example, rather than being application programs 154, the central receiving module 131, the central analyzing module 132, the failure prediction module 135 and the supply prediction module 136 may also be incorporated into the operating system 152 or other such logical division of the data processing system 100, such as dynamic linked library code. Furthermore, while the central receiving module 131, the central analyzing module 132, the failure prediction module 135 and the supply prediction module 136 are illustrated in a single data processing system, as will be appreciated by those of skill in the art, such functionality may be distributed across one or more data processing systems. Thus, the present invention should not be construed as limited to the configuration illustrated in FIG. 1B, but may be provided by other arrangements and/or divisions of functions between data processing systems. For example, although FIG. 1B is illustrated as having multiple modules, the modules may be combined into three or less or more modules may be added without departing from the scope of the present invention.

Referring to FIGS. 1A and 1B, the central receiving module 131 is configured to receive the sensed data associated with the buildings and sensed data associated with one or more other buildings. As discussed above, the more buildings from which data is collected, the more accurate the model and comparisons may be. The central receiving module 131 may also receive non-sensed data 128 without departing from the scope of the present invention. The central analyzing module 132 may be configured to analyze the received sensed data associated with the building and the one or more other buildings. The local receiving module 123 may be configured to receive, from the central processor, a control modification based on the analyzed sensed data. The local data processing module 125 may be configured to modify the local performance metrics and/or specifications associated with the building based on the control modification. For example, the performance metrics and/or specifications of a particular building may be being met or even exceeded, i.e. the sensed data is in line with the performance metrics and/or specifications. However, when the performance metrics and/or specifications of the building are compared to similar buildings, such as buildings of the same size, price range and the like, the performance metrics and/or specifications of the building may be being exceeded by performance of similar buildings. Accordingly, the performance metrics and/or specifications of the building may be changed based on the specifications being met by the other similar buildings. Thus, according to some embodiments of the present invention, climate control systems that appear to be operating within performance metrics and/or specifications at a local level, may be further improved by comparing the performance of the climate control system in the building with the performance of climate control systems in similar buildings, i.e., systemic problems may be identified and corrected.

Once the local performance metrics and/or specifications 130 are modified, the local comparison module 126 may be configured to compare the received sensed data with the modified local performance metrics and/or specifications. The local adjustment module 125 may be configured to adjust the climate based on a result of the comparison of the received sensed data and the modified local performance metrics and/or specifications associated with the building.

In some embodiments of the present invention, the local data processing module 125 is further configured to modify the predictive data 129 based on the control modification. As discussed above, the predictive data 129 may be associated with a reference model for the building, which will be discussed further below with respect to FIG. 3.

In some embodiments of the present invention, the local data processing module 124 may be configured to process the reference data before providing the reference data (sensed and/or non-sensed) to the central receiving module 131 of the central processor 105. For example, the amount of the reference data may be organized and reduced, normalized and/or used in calculations. In particular, the reference data may be processed at the building and reflect various physical and operational attributes of the building, such as square footage, roof surface, insulation type and material, amount of window surface, type of glass used in windows, orientation and geographic location of the building, infiltration at various wind speeds, heating and cooling expenses, and the like.

In some embodiments of the present invention, the local data processing module 124 may be configured to anonymize the reference data before the reference data is received at the central processor. The reference data may be anonymized to protect the privacy of the building occupants. However, for data analysis and model-building according to some embodiments of the present invention, the reference data can be associated with a particular building over time with the known characteristics of the building, for example, type of construction materials, number of square feet, volume of conditioned space, and longitude/latitude coordinates, or at least a rough idea of where the building is located geographically, so that regional climate conditions can be considered.

In order to allow these data elements to be related to one another, in some embodiments of the present invention, each building may be individually identifiable in the data set. For example, when data is obtained for the data set, each building may be associated with a corresponding identifier(s) used for the data records in the data set. Furthermore, in some embodiments of the present invention, an encryption methodology may be used in which one or more secret keys may be used to encrypt each building's true identifier into one or more anonymous identifiers. The anonymous identifiers may be used within the data set. The anonymous identifier for a given building will not typically change over time, so that data collected over time can be analyzed within the same frame of reference. In order to further obscure the data, in some embodiments of the present invention different data elements may use anonymous identifiers produced by different keys. For example, user interface transactions can be identified using one anonymous identifier, construction details using another, and performance data using a third. Each set of identifiers may be produced using a separate set of secret keys. These keys can be held by different parties, so that in order to combine the different data elements, multiple participants would have to be involved. This may reduce the likelihood that one party, holding only one of the keys, could violate the privacy policies of the organization. Joining these data sets together, to produce the complete picture of a building, may require the explicit cooperation of multiple parties.

Encryption methodologies are known to those having skill in the art and, therefore, will not be discussed in detail herein. In particular, various encryption algorithms and secret key mechanisms may be used to implement this anonymization strategy without departing from the scope of the present invention. For example, standard symmetric block ciphers, an asymmetric public/private key mechanism, or a combination thereof, may be used, as is common in other computer encryption systems. Alternatively, hashing algorithms, such as SHA1/SHA2, MD5, and the like may be used as a one-way encryption system.

In some embodiments of the present invention, the local receiving module 123 may be configured to receive a request for a thermal comfort condition and/or a request for an indoor air quality condition. For example, an occupant may issue a request to be cooler. The local adjustment module 125 may be configured to adjust one or more parameters associated with the climate of the building based on the received request so as to allow achievement of the requested thermal comfort condition, i.e., adjust the parameters that will make the occupant cooler. It will be understood that the local data processing module 124 may be configured to convert the received thermal comfort condition (“I want to be cooler”) into a form usable by the local processor to adjust the one or more parameters. Thus, according to some embodiments of the present invention, the occupant can request a thermal comfort condition and control systems according to some embodiments of the present invention may adjust the appropriate parameters to achieve that condition based on the reference data.

In some embodiments of the present invention, a user interface, coupled to the local adjustment module 125, may be configured to receive a request to adjust the one or more parameters associated with the climate in the building. For example, an occupant of the building may request that the temperature of the building be lowered. The local adjustment module 126 may be configured to adjust the one or more parameters, lower the temperature, responsive to the received request. In some embodiments of the present invention, the user interface may be further configured to receive a unique user identification associated with a user entering the request before the request is provided to the local adjustment module 126 so as to allow the request to be associated with the user. According to some embodiments of the present invention, this information may be used to tailor climate parameters to optimize the thermal comfort of particular individuals within the building.

It will be understood that the user interface according to some embodiments of the present invention may be any type of interface known to those of skill in the art, such as a touch pad, key pad, voice activated and the like. It will be further understood that user interfaces according to some embodiments of the present invention may be more than simple displays. For example, a user interface may be a stand-alone computer with a dedicated display. This user interface may be networked to the central processor, and/or may be capable of analyzing user transactions locally, without having to communicate with the central processing system.

In some embodiments of the present invention, the local receiving module 123 may be configured to receive a request to adjust the one or more parameters associated with the climate from a location remote from the building. For example, an occupant of the building may decide to leave work early so that he can get a run on the treadmill before dinner. He may realize on his way home that the temperature in the workout room will not adjust to the workout temperature until 7 PM, his normal workout time. Accordingly, he calls the climate control system and requests that the temperature in the workout room be lowered to the workout temperature now. Thus, when he gets home, the workout room may be at the desired workout temperature. The local adjustment module 125 may adjust the temperature responsive to the received request. It will be understood that in some embodiments of the present invention, the request from the remote location may first go to the central processor and then be forwarded to the local receiving module 123 for security/privacy purposes.

In some embodiments of the present invention, the local adjustment module 125 may be configured to adjust the one or more parameters to maintain a predetermined pressure differential between an interior of the building and an exterior of the building. For example, the predetermined pressure differential may be adaptively maintained by allowing controlled amounts of air into the interior of the building. In particular, all buildings have a certain amount of air leakage, which may be expressed as a percentage of the total indoor air volume that is exchanged per hour (ACH), or as the amount of air (in cubic feet per minute) entering the interior air volume of the building when a pressure difference of 50 Pascals is induced between the indoor and the outside air space, a parameter called cfm50. Imperfections in the building envelope, such as cracks around windows and doors, as well as any gaps between individual construction elements, such as panels, which have not been joined or caulked properly, may all contribute to this leakage. Changes in wind speed and wind direction, as well as the stack effect, which is caused by convection as a response to solar radiation, may all result in pressure variations that can be observed at different parts of the building envelope. Thus, according to some embodiments of the present invention, the magnitude of the average pressure differential may be adapted dynamically and automatically according to current weather conditions, for example, when high outside wind speeds or gusts are detected, a higher average pressure differential may be maintained in order to reduce or eliminate infiltration.

Accordingly, the local receiving module 123 may be configured to receive pressure measurements from a plurality of sensors associated with a building. The local adjustment module 125 may be configured to adjust pressure between an interior of the building and an exterior of the building to maintain a predetermined pressure differential between the interior of the building and the exterior of the building.

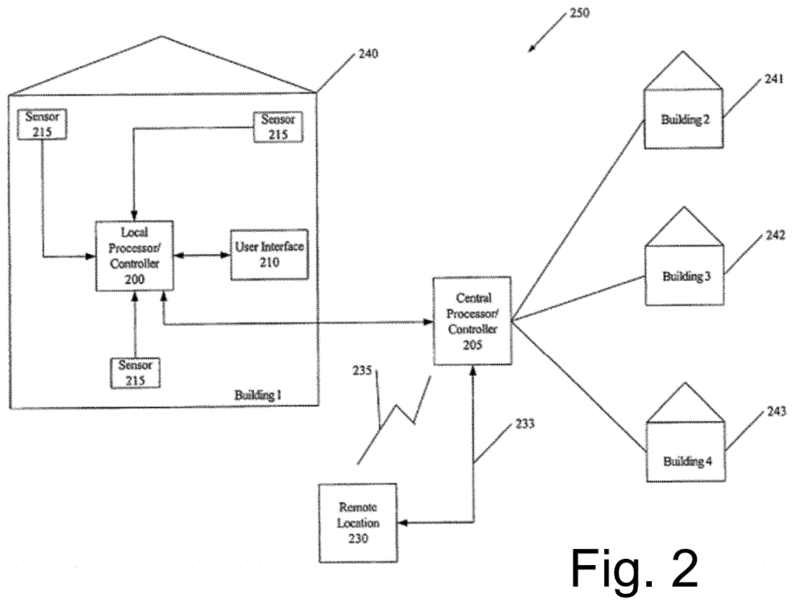

As discussed above, a central processor 105 may be coupled to at least two local processors (100 of FIG. 1A) associated with at least two corresponding buildings as illustrated in FIG. 2. The central receiving module 131 may be configured to receive reference data from the at least two buildings. As discussed above, each local data processor receives reference data collected by one or more sensors positioned inside and/or outside the associated building. The central analyzing module 132 may be configured to analyze the reference data received from the building. For example, the central analyzing module 132 may be configured to compare and/or aggregate reference data from one building with reference data from one or more other buildings. For example, the central analyzing module 132 may identify a pattern in behavior associated with one or more occupants of the building. For example, it may be observed from the reference data that a particular occupant always exercises at a particular time of day and usually adjusts the temperature of the workout room upon beginning his workout. According to some embodiments of the present invention, the occupant's pattern may be recognized and the temperature in the workout room may be adjusted 15 minutes before the usual workout time without any interaction with the occupant. Thus, the temperature in the work out room may be exactly where the occupant wants it before the workout begins.

In some embodiments of the present invention, performance metrics and/or specifications for a particular building may be analyzed. For example, it may be determined if performance metrics and/or specifications are being met based on the reference data. Thus, according to some embodiments of the present invention the performance metrics and/or specifications of a particular building may be compared to similarly constructed buildings in a similar climate region and indoor climate parameters may be adjusted accordingly. Furthermore, in some embodiments of the present invention, it may be determined if the performance metrics and/or specifications need to be updated, for example, based on changed circumstances, changed preferences of an occupant of the building and/or aging processes that may affect the building.

As discussed above, in some embodiments of the present invention requests from a remote location for a particular building may be routed through the central server 105 for security purposes. In these embodiments of the present invention, the central receiving module 131 may be further configured to receive a request to adjust one or more parameters associated with the climate of a particular building and the request may be forwarded to the particular building.

It will be understood that although the examples provided herein largely relate to adjustments of temperature, embodiments of the present invention are not limited by these examples. For example, in some embodiments of the present invention the failure prediction module 135 may be configured to use the aggregated reference data from multiple buildings to predict equipment failure. Furthermore, in some embodiments of the present invention, the supply prediction module 136 may be configured to predict an amount of supplies needed to construct a new building based on the aggregated reference data associated with multiple buildings. For example, during the construction process, the building contractor may determine how much insulation should be purchased for the building. Using aggregated reference data according to some embodiments of the present invention, the building contractor may obtain data on the amount of insulation installed in buildings having square footage similar to the current building, in a similar price range, in a similar climate and the like. The building contractor may also obtain centrally processed reference data about energy costs and consumption associated with these buildings. This information may be used to determine exactly how much insulation should be purchased for the current building. For example, two buildings with X amount of insulation consumed a certain amount of energy and two other buildings with Y amount of insulation, less than X, consumed as little if not less energy. Thus, the building contractor knows that the added amount of insulation (X-Y) was not worth the cost in energy savings. Therefore, money may be saved in the purchase of insulation.

Referring now to FIG. 2, a climate control system including local and central data processing systems according to some embodiments of the present invention will be discussed. As illustrated in FIG. 2, a climate control system 250 according to some embodiments of the present invention may include first through fourth buildings 240, 241, 242 and 243, a central processor/controller 205, and a remote location 230. As further illustrated in FIG. 2, the first through fourth buildings 240, 241, 242 and 243 are coupled to the central processor/controller 205. The central processor/controller 205 may communicate with the first through fourth buildings 240, 241, 242 and 243 using, for example, a protocol that has been optimized, or adapted specifically for the purpose of this type of communication by incorporating, for example, explicit or implicit references, pointers or locators for processed reference data, performance metrics, time stamps, authentication codes, or anonymization process related variables.

As further illustrated in FIG. 2, the first building 240 (as well as the second through fourth buildings, although not illustrated in FIG. 2) includes one or more local processor/controllers 200, a user interface 210 and sensors 215. The user interface 210 and the sensors 215 are coupled to the one or more local processor/controllers 200. It will be understood that although only a single user interface 210 and three sensors 215 are illustrated in FIG. 2, embodiments of the present invention are not limited to this configuration. For example, two or more user interfaces 210 and hundreds of sensors 215 may be provided without departing from the scope of the present invention.

The local processor/controller 200 may include the modules and operate as discussed above with respect to FIG. 1A. Similarly, the central processor/controller 205 may include the modules and operate as discussed above with respect to FIG. 1B. The sensors 215 may be analog and/or digital and wired and/or wireless without departing from the scope of the present invention.

FIG. 2 further illustrates the remote location 230. This location may be, for example, a cell phone, office phone or the like, or any device with IP protocol enabled communications. A request may be received from the remote location from an occupant or owner of the building 240 or from any person given access by the owner, for example, HVAC personnel. The request may be provided over a physical connection 233 or wirelessly 235 as illustrated in FIG. 2. As discussed above, the request from the remote location 230 may be routed to the central processor 205 for security purposes. However, the request may be sent directly to the local processor 200 without departing from the scope of the present invention. It will be understood that the system 250 is described for exemplary purposes only and the embodiments of the present invention are not limited to this configuration.

According to some embodiments of the present invention, there are at least seven principal stages within the life cycle of a building and the associated local processing system (i.e., design, engineering, construction, marketing, sales, financing, and day-to-day operations), each with its own unique data acquisition, processing and analysis requirements. The first is the initial planning stage, when functional requirements for the building and its occupants are determined. Another one is the construction process, when it is verified that the building and its parts are built according to these specifications. During the ongoing operation of the building, the building and its parts are maintained such that the original or subsequently defined performance objectives are met on an ongoing basis. It will be understood that embodiments of the present invention may be used in all seven or more stages or in only one or two of these stages without departing from the scope of the present invention.

During the planning stage, reference data is accumulated from architects, builders, home owners and the like. Reference data may include structural, HVAC equipment, air quality, and energy consumption variables, as well as implicit and explicit personal comfort variables of the occupants, such that they can be used by control systems according to some embodiments of the present invention to generate a comfortable and healthy environment for the occupants (individually and collectively) throughout the building, and also, if desired, for individual rooms.

The planning reference data is particularly useful when it is compared to the aggregated reference data from each of the buildings coupled to the central processor. The comparison results may be useful references for, for example, builders (“how did we do, compared to our competition”), HVAC equipment manufacturers (“how is our equipment doing, as installed in this particular instance, and also compared to an average installation”) or HVAC contractors (“how was my installation crew performing this time, as compared to our previous installations, and to the industry average”).

During the construction phase, for the purpose of constructing an airtight shell, and to ascertain the achievement of specified objectives, measurements can be taken at several stages of the actual construction. For example, a blower door test may be performed once the frame has been erected and the building envelope has been completed, including the installation of windows and doors, but before any of the drywall is installed on the inside. The blower door test may be conducted such that additional insulation and caulking can be performed during the test until a certain leakage threshold is reached. This threshold may be determined based on calculations and on data from the reference database that have been adapted to the specific circumstances of that particular building and its stated performance metrics and/or specifications.

Another measurement that can be performed during construction is the continued observation of the moisture content of certain structural components of the building. Using indoor climate control systems according to some embodiments of the present invention, these measurements can be performed throughout the construction process, with the data transmitted back continuously to the central database. Once the observed data exceeds a certain threshold that has been determined based on previous construction data stored at the central processor, and corrected for local climate conditions, the builder can be notified, and he can take appropriate remedial action. Certain indoor air quality requirement specifications, determined earlier during the planning stage, may not be able to be met later on if the moisture content of the building structure exceeds certain levels at a point in time, for example, when these structural members are about to be enclosed, and do not have the ability to dry out further, which may result in mold growth, structural deterioration, and serious indoor air quality problems.

Some embodiments of the invention involve the formulas used for the calculation of performance thresholds during construction that use observed building performance data and planning data, and combines the observed building performance data and planning data with reference data that has been adapted and modified to reflect the specific circumstances of a particular building.

Thus, according to some embodiments of the present invention, construction stage data is collected on an ongoing basis and may be related back to the aggregated data at the central processor. Performance parameters for specified classes of buildings may be provided as reference data, so that a builder can check on the progress and the performance of his construction project, knowing that he is on track to reach certain structural performance objectives by the time the building is finished.

During the operation stage, after the building has been occupied by the owner, performance data may be acquired and stored on an on-going basis in (but not limited to) the areas of, for example, thermal comfort, indoor air quality, equipment performance, energy consumption and conservation, and/or the protection of the structure and the property it contains. There are two overall objectives associated with this data acquisition. The first one is to ascertain that performance metrics and/or specifications are being met, and the second one is to detect if any of these performance requirements are changing due to changed circumstances or preferences of the home owner, or due to normal aging processes that affect the structure, such as decreasing effectiveness of insulation materials, or decreased air tightness.

The collection of reference data associated with the operation of the occupied building may be useful for a number of benchmarking activities by equipment and building material manufacturers, or for comparisons of energy efficiency of certain types of structures and their components over time and under specific weather conditions.

Referring now to FIG. 3, a block diagram illustrating an example climate control system (MRAC system) according to some embodiments of the present invention will be discussed. As discussed herein, embodiments of the present inventive concept are not limited to a specific “model,” accordingly, details with respect to FIGS. 1A through 3 are provided for example only. As illustrated in FIG. 3, the climate control system 301 includes a local data processor 300 and a central processor 301. Furthermore, the local data processor includes a reference model 310, a local building controller 303, a building (plant) 340 and an adjustment module 326. As further illustrated, the central processor 305 includes the aggregated reference data 367, which may include both sensed and non-sensed reference data as discussed above.

First, the local data processing system 300 and the elements thereof will be discussed. In particular, the local building controller 303 generates input parameters for the plant 340, such as, close the damper, turn on the heat, turn on the AC and the like. Since the building (plant) 340 is not linear or time invariant, it experiences state changes due to windows opening, weather changes, humidity changes and the like. The local data processing system 300 is capable of adjusting the climate in the building based on the reference data, sensed, non-sensed, predictive and performance metrics and/or specifications. Control algorithms of the controller 303 may be adjusted to achieve similar results in the future based on past data. Details with respect to the model reference adaptive control approach as discussed with respect to FIG. 3 are discussed in Robust Adaptive Control to P. A. Ioannou et al. (Prentice Hall, 1996, p. 314), the disclosure of which is hereby incorporated herein by reference as if set forth in its entirety.

As further illustrated in FIG. 3, the reference model 310 and the building controller 303 are updated by the central processor 305. For example, the local processing system 300 may appear to be operating flawlessly, however, when the actual sensed data from the building is compared to sensed data from other similar buildings, a systemic problem may be revealed. For example, the building may be consuming 10 percent more energy than the other similar houses. Accordingly, the reference model 310 may be updated such that the output of the reference model (predictive data) reflects the energy efficiency of the other buildings. The controller 303 may then adjust the parameters to achieve the desired efficiency.

As discussed above, the reference model according to some embodiments of the present invention is unique due to the derivation and the ongoing modification of the reference model 310 based on reference data 367 collected from different buildings. For example, when embodiments of the present invention are used in conjunction with a newly constructed building, the initial parameters for a reference model that is unique for that particular building may be derived from initial specifications collected during the planning phase of the building and from aggregated reference data 367 collected previously from other buildings coupled to the central server (205 FIG. 2). Once the initial reference model 310 is constructed, it will be adapted and modified for the specific circumstances and operating conditions of this particular newly constructed building according to some embodiments of the present invention.

In particular, before the newly constructed building is occupied, the local processor controller (200 of FIG. 2) will move through a set of operating conditions which may allow the unique responses of the newly constructed building and its various components to be observed at that point in time; in essence, data that reflects the transfer function of the building envelope at the end of the construction phase is being collected and analyzed. This set of data allows modification and refining of the reference model 310 even further, such that the reference model 310 can be adapted to the specific set of operating variables and set points of the building before the occupants have moved in.

Once the occupants move into the building, the control system may further adapt to the specific preferences of the occupants. The feedback from the occupants may be collected, for example, through the typical data acquisition and aggregation process described above. For example, the reference data is collected by the sensors (215 of FIG. 2) positioned inside and/or outside the building. Thus, the building is observed, and all the observed parameters that reflect the particular state of the building at any given point in time, as well as the interaction of individual occupants with the user interface (210 of FIG. 2) of the control system at this time, and in the context of specific indoor climate and system operating conditions.

For control systems according to some embodiments of the present invention, the (unknown) thermal comfort condition (“state”) of each of the occupants may be deduced from observed occupant transactions, or the absence thereof. This information may be translated into specific state transitions of the climate control system. In particular, in some embodiments of the present invention, there are two modes of operation for the occupant state acquisition process. The first one is a passive observation mode as described above. Reference data associated with all relevant entities, i.e., the state of the building, the state of the climate control system, and the state of the occupants, is collected and analyzed over time, and translated into corresponding state transitions by the control algorithms of the control system (301, 303).

The second mode may be characterized by a steady state of all relevant entities as the starting point. The control system may then initiate a state transition, such as an increase in the speed of air circulation, or a step function in temperature, and observe the responses it receives from the occupants by way of user interface (210 of FIG. 2) transactions. As thermal comfort is generally dependent upon a number of independent environmental conditions, as well as certain genetic, physiological and psychological variables that are specific for each particular individual, control systems according to some embodiments of the present invention may have a complex set of state transitions that may eventually lead to a stable conclusion about the actual state of thermal comfort for a particular occupant.

In other words, individual occupants can therefore “teach” the climate control system according to some embodiments of the present invention about their own particular climate preferences, for a set of different situations, for example, “I'm going to sleep now”, “I'm working out in the exercise room”, or “I want to sit in the living room and watch TV.” As discussed above, the user interface, according to some embodiments of the present invention, has a provision for each individual to identify himself or herself before making an entry. Thus, when several occupants are all present in a single room, the system may try to accommodate them collectively.

Thus, according to some embodiments of the present invention, each occupant may have the ability to define any number of personal climate preferences, and call anyone of them up for a particular room anytime they want. Furthermore, by observing the state of the building under various outdoor climate conditions, the control system 301 according to some embodiments of the present invention may also acquire a detailed knowledge about the performance of the building under these climate conditions, and may modify/adjust its state transitions accordingly.

As discussed above, systems according to some embodiments of the present invention include a centrally located processor/controller (205 of FIG. 2). The central processor may have remote access to all local processors/controllers (200 of FIG. 2) at all times. One benefit of this arrangement may be redundancy, and thus significantly increased reliability for individual building control systems. Furthermore, as discussed above, the ability to observe many individual control systems and their state transitions under a wide range of operating conditions may provide useful aggregated reference data 367. A central processor 305 may observe all relevant input, reference model, and building output vectors at all times. This may allow all connected systems to be monitored for quality control purposes. As further discussed above, it may also provide a host of individual system performance data (reference data) that can be used collectively to derive better performing control system algorithms. Similarly, reference models can be improved over time. The aggregated reference data 367 may be used to, for example, configure new local processors 300 before they are installed by, for example, adapting relevant parameters of the new system to the specific requirement specifications and structural variables of the new building.

Thus, according to some embodiments of the present invention, operating parameters of certain HVAC system components, such as filters, fans, ducts, motorized dampers and compressors, are collected and stored, as well as data that characterize the specific house/building environment and the climate that they are operating in, plus their energy consumption. Some embodiments of the present invention combine the collected information with specific records about user transactions, which determine on-off cycles, run times, aggregate machine hours, and the like, and which have a significant effect on the longevity and durability of many of these system components. According to some embodiments of the present invention, the records are organized and aggregated by type of equipment, model and serial number across a number of different operating conditions and types of home environments at the central processor, for example.

Thus, according to some embodiments of the present invention, ongoing analysis of several concurrent time series of equipment performance and user transaction data that are being collected under well documented building internal and external climate conditions may be possible. By comparing data from individual buildings with those that have been aggregated across many different types of buildings and operating conditions, otherwise invisible patterns may become apparent, and previously unknown failure modes may be identified and analyzed for the first time.

Some embodiments of the present invention combine local and remote real-time data analysis, thereby allowing equipment performance degradations to be recognized quickly, and appropriate maintenance efforts to be scheduled in a much more timely manner. Significant energy savings, and increased equipment longevity may also result.

As discussed above, in some embodiments of the present invention a very tight and well-insulated building envelope may be an important prerequisite for the effectiveness and the energy efficiency of the indoor climate control systems discussed herein. Such a building envelope provides an energy efficient way to maintain a predetermined pressure differential between the building interior and exterior under most weather conditions and, thus, may allow the reduction in unwanted infiltration or exhaust. This pressure differential can be adaptively maintained by bringing in controlled amounts of treated outside air. The tighter the building, the lower the amount of air that is required to maintain the desired building pressure.

Pressure differences between different parts of the building envelope may originate from a combination of wind speed, wind direction, and stack effect. Sensors (215 of FIG. 2) may be configured to capture pressure differentials between major outside wall surfaces and the inside of the building and/or individual rooms of the building. The signal from these sensors may be of suitable resolution and frequency response to control fan speeds and the position of dampers that regulate the amount of outside air that is brought into the building and/or individual rooms of the building, thereby creating the desired pressure differentials across each of the exterior walls. The signal may also allow pressure changes to be recognized that are caused by temporary events, such as open doors or windows, the use of kitchen exhaust fans, central vacuum systems, clothes dryers, bathroom fans, opened fireplace dampers, and the like. Thus, avoidance of the depressurization of the building for extended amounts of time may be desirable, especially in rainy weather conditions, or if outdoor air pollution is a major concern. In most of these cases, the system according to some embodiments of the present invention may respond close to, or in real-time in order to minimize the amount of infiltration caused by any depressurization.

Recent developments have led more and more indoor climate and thermal comfort experts to assert that humans do, in fact, have the ability to acclimatize, i.e., adapt to different climate and temperature environments over time. Thermal comfort as such is reasonably well understood, and is assumed to depend on individual variables, such as the level of metabolism, both at rest and for various levels of physical activity, the number and concentration of sweat glands, and on the amount and the type of clothing a person is wearing. It further depends on the temperature and the relative humidity of the surrounding air, as well as the volume and the velocity of the local air circulation. Also important is the temperature of local surfaces in the vicinity of the individual, providing radiative heat gain or loss. If a person enters a warmer or a colder climate, biological adaptation mechanisms may begin to play a role that is not all that well understood at this time. It may take at least several days for a person to be comfortable again in a climate zone with significantly different average temperatures and relative humidities.

In a building with control over the radiant temperature of all major surfaces, and also of the velocity, temperature and humidity of the circulating air, changing the average indoor climate over time in a controlled manner may not represent a technical problem. If these changes are performed very gradually, and such that they are synchronized with the ability of the occupants to adapt easily to these changes, then such a slow climate change will most likely not even be noticed. The potential advantages are significant. The climate in such a building could gradually follow the seasonal increase or decrease of average temperatures and/or relative humidity, while maintaining close to perfect thermal comfort for the occupants at all times. It would allow them to step outside, for example, and not experience any serious thermal discomfort, and also save significant amounts of energy along the way.

The significant level of detail provided by some embodiments of the present invention about the particular state of the building itself, and of the state of the equipment involved in HVAC and indoor air quality control at any given point in time, may allow the provision of a much more sophisticated level of energy management than what is currently available on the market. For example, some embodiments of the present invention may allow derivation of very specific time constants that describe the response of both the building and/or its structural components and/or its occupants to temperature changes, and therefore allow of use this information to adapt the indoor climate to the variation of electrical utility rate plans or tariffs over the course of the day. In other words, an intelligent form of load management may be provided without compromising thermal comfort, energy efficiency, or indoor air quality.

FIGS. 1A through 3 illustrate an example of a “model” and reference adaptive system (MRAC) in accordance with some embodiments of the present inventive concept, however, as discussed above, embodiments of the present inventive concept are not limited to this specific example. Embodiments discussed herein can be used in combination with any reference model without departing from the scope of the present inventive concept. In particular, any details provided in the current disclosure about the functional implementation of the reference models themselves (the “M”) that are used in these MRACs (i.e., they should be a black box) are provided as examples only and, thus, do not limit embodiments of the present inventive concept in any way by how these reference models might be implemented. Similarly, the type and/or functionality of equipment, such as some implementation of an HVAC system and related equipment that is being used to control certain parameters within the home are not limited to an HVAC system, but can be provided by any applicable system. Thus, embodiments discussed herein are provided for example only and should not be limited by the specific examples herein. In other words, the reference model 310 illustrated in the figures could be any reference model and is not limited to the specific reference models discussed herein.

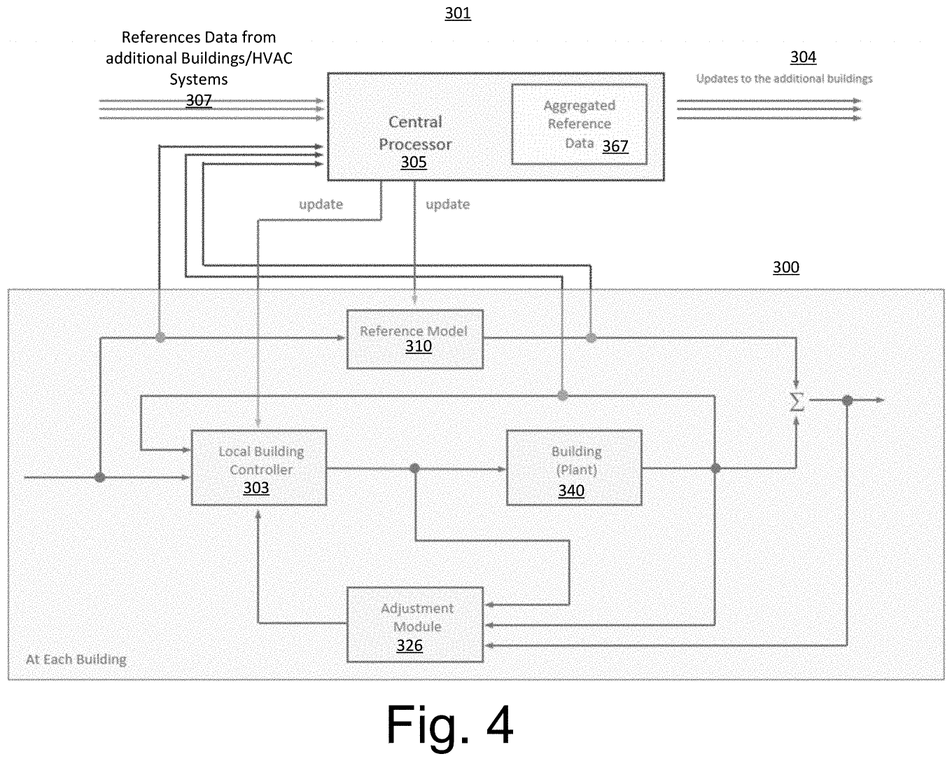

Referring now to FIGS. 3 through 12, diagrams of various configurations of MRACs in accordance with embodiments of the present inventive concept will be discussed. In each of FIGS. 4 through 12, the system 301 of FIG. 3 is duplicated in various configurations. However, again, even though all systems include a reference model 310, embodiments of the present inventive concept are not limited thereto. Like reference numerals refer to like elements throughout, therefore, details of the various elements of the systems may not be repeated herein in the interest of brevity.

Although the figures depict individual “buildings” or “homes,” it will be understood that embodiments of the present inventive concept may be directed to one or more HVAC systems themselves, which may be positioned in one or more buildings. As used herein, an “HVAC system” refers to a system that includes, but is not limited to, for example, various arrangements of return and supply ducts, outside air intake ducts, manually operated or motorized and remotely controlled dampers that regulate air flow, airflow, air temperature and/or humidity, air pressure, carbon dioxide concentration, and/or indoor air quality sensors, or one or more thermostats.

Thus, some embodiments of the present inventive concept relate to methods, systems and computer program products that are used to measure, verify and control the energy efficiency of residential and light commercial HVAC systems, installed in a detached single family home, or in commercial buildings, for example (“buildings”), as a function of (among other variables and given parameters) the type of HVAC system, its system capacity, physical and mechanical properties of building envelopes, the local climate, the quality of the indoor climate, the thermal comfort provided by these structures, and the cost of electrical power and energy available at the location of these buildings.

In other words, some embodiments of the inventive concept involve one or more buildings that have one or more HVAC systems installed, comprised of the HVAC equipment itself (plus additional arrangements, as described in [00106], collectively called an “HVAC system”). The determination and quantification of the energy efficiency of these HVAC systems, individually or in conjunction with each other, involves the measurement of a number of parameters, such as, but not limited to, airflow through various parts of ducts, air flow through the expansion coil, enthalpy before and after the expansion coil, spatial and/or temporal distribution of temperature and humidity of the air both when it enters or exits ducts, and/or the expansion coil.

The determination and quantification of the “energy efficiency” (defined above) of these HVAC systems may include the calculation of certain ratios, such as, but not limited to, for example, the energy efficiency ratio (EER) which is measured in BTU/Wh.

The calculation of the energy efficiency ratio (EER) involves the determination of the system capacity, measured in BTU/h. Some embodiments of the inventive concept involve the implementation of an MRAC where the reference model provides specific values for the system capacity of the HVAC equipment, either collectively as the system capacity of the HVAC system, or separately as the sensible and the latent system capacities (collectively the “system capacity”), as a function of specified parameters, such as, but not limited to, thermostat settings, heating and/or cooling loads, levels of ventilation with outside air (measured with a metric such as, but not limited to the number of cubic feet per minute, for example), time periods of ventilation with a specified level of outside air, specific geographic locations, orientation of the building, solar gain and/or thermal mass of the building, specific microclimates, specific types and/or sizes and/or configurations of HVAC equipment, for any given point in time, or for a specified time period, for example.

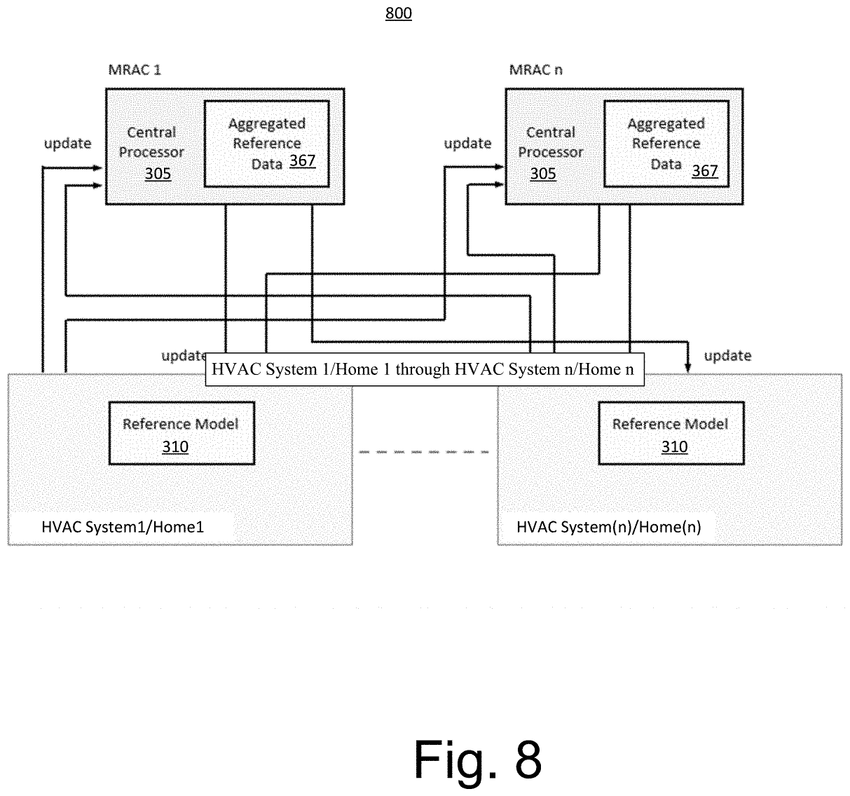

In some embodiments of the inventive concept involve one or more MRACs (whole system 301 of FIG. 3) either separately or in combination, to control heating & cooling, ventilation with outside air, indoor air quality, and degrees of pressurization of one or several individually separated inside air spaces, in HVAC systems in one or more homes. Various inputs (e.g. reference data from additional building/HVAC system 307) and outputs (updates to additional buildings/HVAC systems 304) of these separate MRACs can interact with each other and can also operate independently. An independent MRAC is illustrated in FIG. 3 and an example system including more than one MRAC is illustrated, for example in FIG. 8. Input 307 and output 304 parameters for MRACs that control individual processes can be combined or interconnected in hierarchical and non-hierarchical network structures (“interconnected MRACs”) in order to achieve higher quality and/or more accurate outcomes as will be discussed further below.

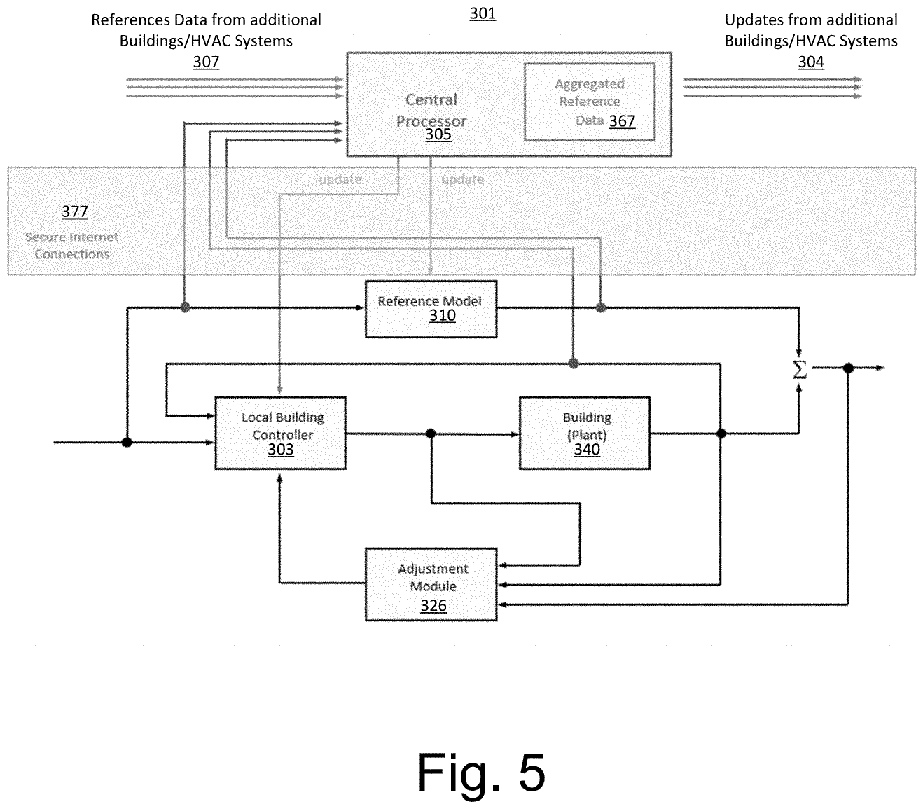

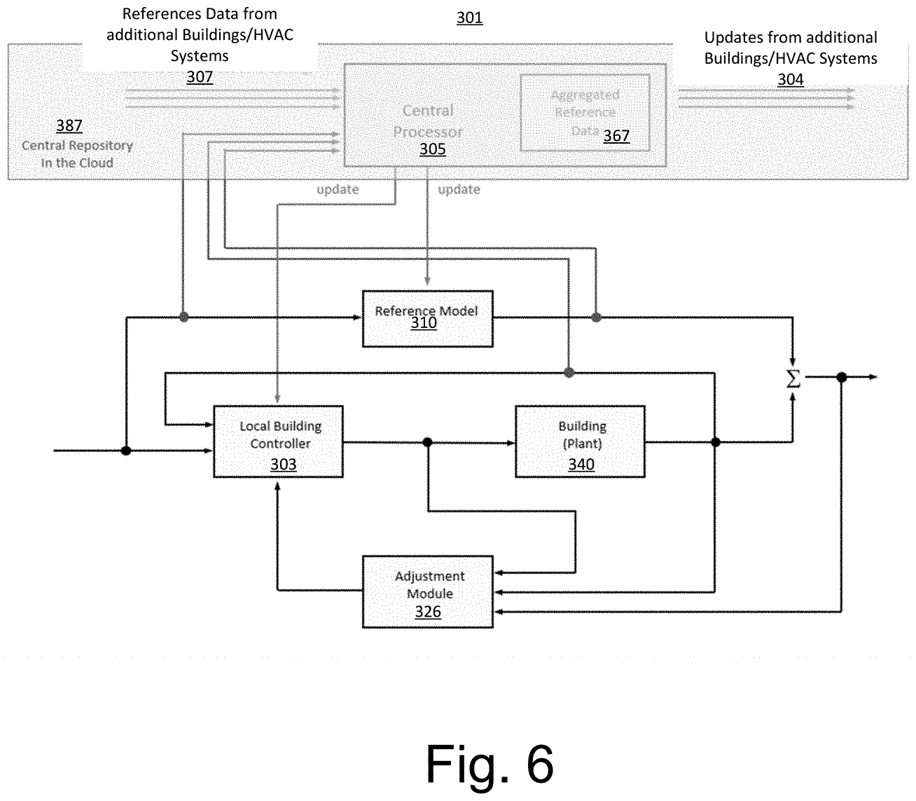

FIGS. 3 through 6 are block diagrams illustrating a same or similar system 301 having different portions of the system highlighted. FIG. 3 and included elements have been discussed in detail above. In FIG. 4, the reference module 200 portion of the system 301 is highlighted. As indicated in FIG. 4, this portion 300 of the system 301 may be included at each HVAC system/building in the network. In other words, each HVAC system/building (or a subset thereof) may have a dedicated reference model 300 associated therewith or therein. FIG. 5 illustrates the communications 377 between the reference model portion of the system 301 and the central processor 305. As indicated therein, this data, updates to and from the reference model, are communicated over a secure connection. These connections may be wired or wireless without departing from the scope of the present inventive concept. In some embodiments, the data is communicated in the form of a “packet” and the destination of the packet may be specified in a header of the packet. Finally, FIG. 6 highlights the central processor portion of the system 301. In some embodiments this portion of the system 301 may be located in the cloud 387, for example, a central repository in the cloud. However, embodiments of the present inventive concept are not limited thereto. As used herein, the “cloud” refers to networked computing facilities providing remote data storage and processing services via the internet.

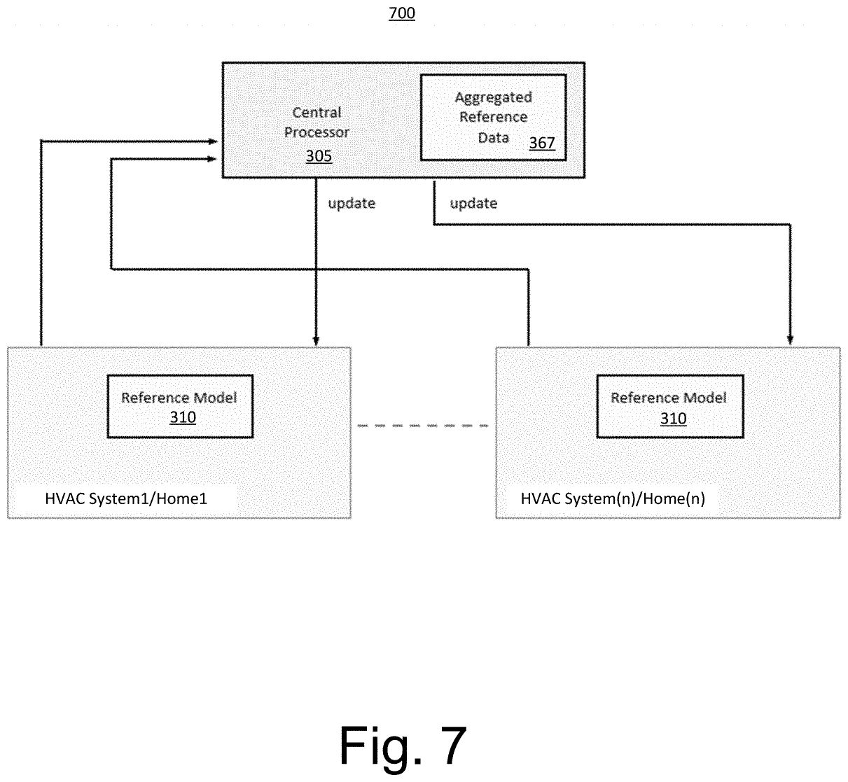

As illustrated in FIG. 7, the system 700 includes a plurality of HVAC systems in homes, for example, HVAC System 1/Home 1 through HVAC System n/Home n, including local reference models 310 that are coupled to a central processor 305 including aggregated reference data 367. As further illustrated, the aggregated data 367 of the central processor 305 is updated with data from all the HVAC systems/homes 1 through N and the reference models 310 in HVAC Systems/Homes 1 through n are updated by the central processor 305. It will be understood that although HVAC systems/Homes 1 through n are shown in FIG. 7 as only including the reference model 310, the remaining components of element 300 of FIG. 3 are also present but are not shown in the interest of brevity. In some embodiments of the inventive concept, the one or more HVAC systems/Homes (1 to n of FIG. 7) have a variety of distinctly different physical properties, including but not limited to:
A specific geographic location with a unique variation of the local climate throughout the seasons (“microclimate”);
Outside walls of the home facing either north, south, or any number of degrees in between (“orientation”);
One or more floor levels; the surface area of each of these one or more floor levels;
Attached/integrated or detached garages;
Various pitches of roofs on various parts of the home;
The number, size and orientation of dormers;
Various degrees of roof overhang;
Various numbers, locations, and sizes of windows that have various levels of solar heat gain coefficients (“SHG”) and/or various levels of air leakage as a function of the stack effect and/or of windspeed and wind direction;
Various numbers, locations, and sizes of outside doors that have various levels of solar heat gain coefficients (“SHG”) and/or various levels of air leakage as a function of the stack effect and/or of windspeed and wind direction;
Entire sets or subsets of foundations consisting of concrete slabs, crawlspaces or full basements constructed with a range of building materials (“foundations”);
Entire sets or subsets of foundations, walls, ceilings, floors, attics, and roofs with different levels of thermal insulation;
Entire sets or subsets of foundations, walls, ceilings, floors, attics and roofs with different levels of infiltration (air leakage);
Entire sets or subsets of foundations, walls, ceilings, floors, attics, and roofs with different levels of thermal insulation, for example, spray insulation versus foam insulation; and
Entire sets or subsets of walls, ceilings, floors, attics and roofs with different amounts of thermal mass; and the like.

All of these parameters and/or physical properties may or may not affect the levels of “energy efficiency” as defined above for these homes.

As used herein “SGH” refers to the amount of solar radiation, or heat, that passes through windows into the home. It will be understood that “N” or “n” can be any non-zero number. Furthermore, although FIG. 7 illustrates one central processor associated with N HVAC systems/homes, embodiments of the present inventive concept are not limited thereto. For example, each HVAC system/home or group thereof may have a unique central processor without departing from the scope of the present inventive concept. An example of HVAC systems in homes having unique central processor where the central processors are interconnected is illustrated in, for example, FIG. 8, which is discussed further below.

Referring now to FIG. 8, a block diagram illustrating a system 800 including a plurality of MRACs (interconnected MRACs) MRAC 1 to MRAC n coupled to a plurality of corresponding HVAC systems in homes, Home 1 to Home n, respectively, in accordance with some embodiments of the present inventive concept will be discussed. FIG. 8 illustrates the interconnections of MRACs with each other as well as HVAC systems in homes. As will be discussed further below, the system in accordance with embodiments discussed herein may include a plurality of MRACs as well as a plurality of HVAC systems in homes or groups of homes and these MRACs and groups of HVAC systems in homes may be organized hierarchically to provide information about various HVAC systems in homes, groups of homes etc. Although FIG. 8 illustrates a simplified version of the reference model 310 in HVAC system in homes Home 1 to Home n, it will be understood that all components of the reference model are present, for example, element 300 of FIG. 3.

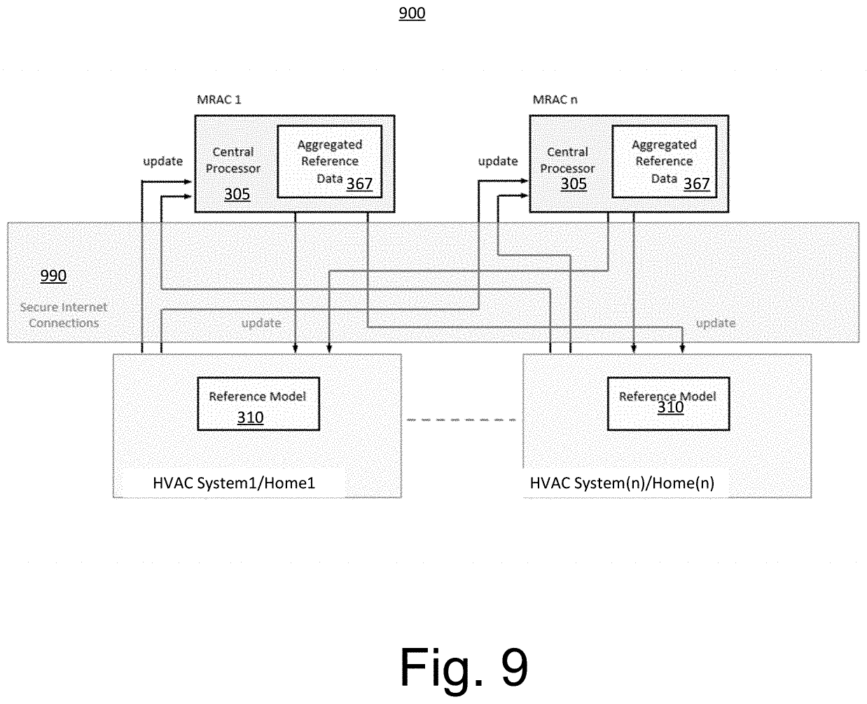

FIG. 9 is similar to FIG. 8 and included elements have been discussed in detail above. In the system 900 of FIG. 9 FIG. 9, the communications 990 between the reference model portions of the HVAC system at each home of the homes Home 1 through Home n and the plurality of MRACs MRAC 1 through MRAC n is highlighted. As indicated therein, this data, updates to and from the reference model in the HVAC system in the home, are communicated over a secure connection. As discussed above, these connections may be wired or wireless without departing from the scope of the present inventive concept. The data may be sent in packets and the packets may have headers indicating where the packet should be sent.

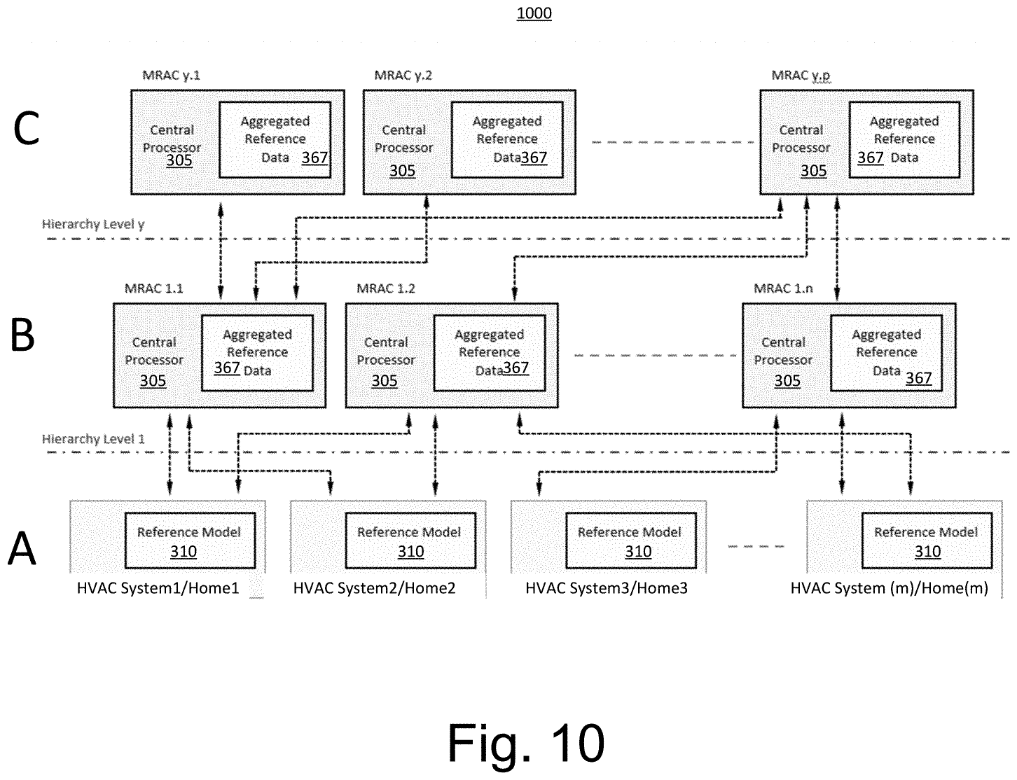

Referring now to block diagrams of FIGS. 10 through 12, embodiments of the present inventive concept having various levels of hierarchies will be discussed. As illustrated in FIG. 10, the system 1000 includes a plurality of HVAC systems/homes (Home 1, Home 2, Home 3 through Home m) each having a local reference model therein, a plurality of MRACs MRAC 1.1, MRAC 1.2 to MRAC 1.n and MRACy.1, MRACy.2 through MRACy.p. As further illustrated, the MRACs are arranged in a hierarchy which allows data from homes to be examined in a more granular fashion as levels of the hierarchy increase. FIG. 10 only illustrates two levels in the hierarchy, hierarch Level 1 (B) and hierarchy Level y (C). It will be understood that in reality there are or may be many levels to the hierarchy and the number of levels is only limited by the data to be gleaned from the various HVAC systems in the homes as will be discussed further below. Thus, many more than two levels of hierarchy may be present without departing from the scope of the present inventive concept.

Referring again to FIG. 10, a series of HVAC systems in homes Home1 through Home m are provided with a reference model 310. As discussed above, these homes may have a variety of distinctly physical properties (examples listed above), some of these properties may be in common and others may be different. For example, some of these homes may be single story homes, while others may be multiple stories high. Some of these homes may be heated with gas and some with a heat pump and the like. Some embodiments of the present inventive concept provide the ability to obtain and store data related to each of these homes and sort this data by commonalities using the hierarchies discussed above. Once the data is sorted and, thereby, ensuring data is being compared with “like” homes, the data can be used to determine if one or more of these homes is operating outside expectations, or if sensed data have been altered or otherwise manipulated to change their original types or values, for example. Once the homes that are not performing as expected are identified, a cause for their performance may be identified and addressed.

An example of hierarchies and obtaining increasingly granular information will now be discussed with respect to FIG. 10. As discussed above, HVAC systems in Homes Home 1 through Home m of FIG. 2 all have specific properties. A first level of hierarchy (B) may categorize homes with a plurality of same features with an MRAC 1.1 through MRAC1.n dedicated to each group of features. For example, MRAC 1.1 may receive information from all one story homes; having a heat pump; being less than 2000 square feet; located in a rural area in the eastern part of the United States and having an attached garage. MRAC 1.2 may receive information from all one story homes; being heated with gas; being greater than 2000 square feet; located in a metropolitan area in the eastern part of the United States and having an unattached garage. Each additional MRAC through MRAC 1.n may have its own set of properties for housing reporting information thereto. It will be understood that although only three MRACs are shown in Hierarchy Level 1 (B) of FIG. 10, embodiments of the present inventive concept are not limited to three MRACs. As discussed above, Level 1 may include as many MRACs for the combination of properties of the HVAC systems in homes Home 1 through Home n without departing from the scope of the present inventive concept.

Similarly, MRACs MRACy.1 through MRACy.p in a higher level of the hierarchy Level Y (C) may further refine the data collected at Hierarchy Level 1 (B) or any hierarchy below. For example, the query for an MRAC on Level Y may be all one story homes in metropolitan areas. The ability to query data to this level of granularity allows data to be compared in a very meaningful way. Thus, making it much easier to find HVAC systems in homes or groups of homes that are operating outside expected performance metrics. Once these homes are identified, the cause may be investigated and addressed.

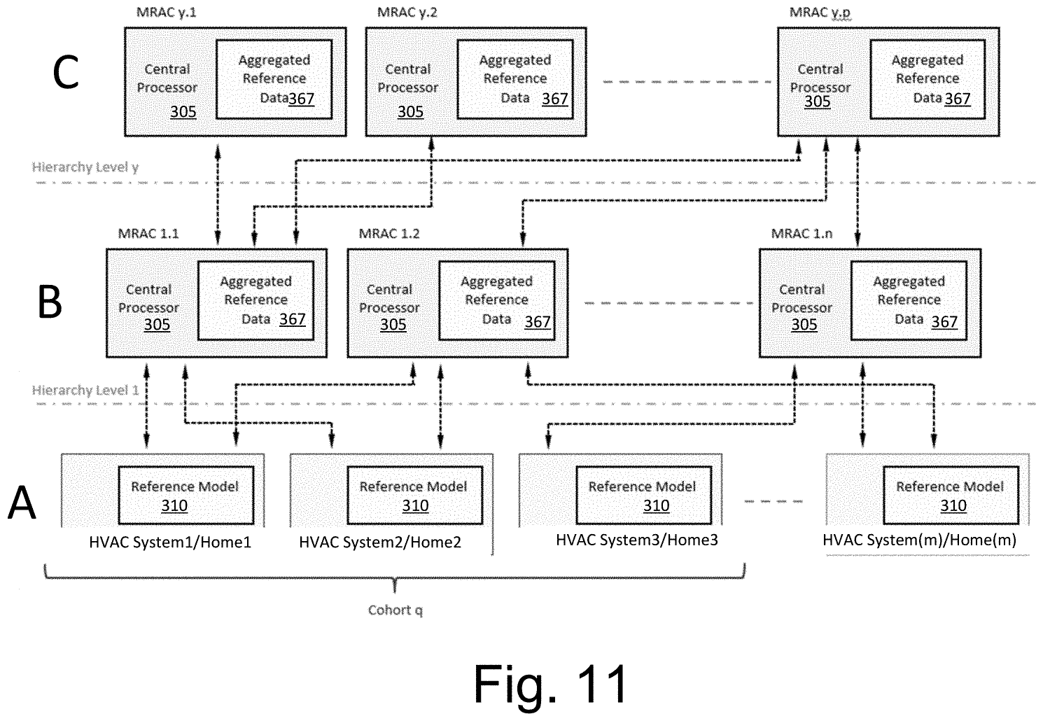

Referring now to FIG. 11, a block diagram illustrating the hierarchical system of FIG. 10 including “cohorts” of HVAC systems in homes or buildings will be discussed. Thus, like elements from FIG. 10 are the same as like elements in FIG. 11 and, therefore, details will not be repeated herein. However, as shown in FIG. 11, Homes Home 1, Home 2 and Home 3 have been grouped into a “cohort,” Cohort q. It will be understood that a cohort can include more or less than three homes without departing from the scope of the present inventive concept.

Referring to FIG. 11, some embodiments of the inventive concept involve one or more MRACs and/or interconnected MRACs to increase the accuracy of the measurement of the energy efficiency of the building envelopes of a group of homes referred to herein as a “cohort” of homes or buildings. As used herein, a “cohort” refers to a group of buildings, for example, homes, that have one or more similar physical or operational properties in common. A cohort of homes is illustrated, for example, in FIG. 11. For example, all of the buildings in a cohort may be about the same square footage, with the same number of windows, heated with gas, have a tankless water heater and the like. The number of homes in a cohort is unlimited and a single building can belong to more than one cohort without departing from the scope of the present inventive concept.

Using the data collected at the homes and/or buildings and creating levels of hierarchy discussed herein may allow detailed data about energy efficiency and related matters to be obtained. For example, in some embodiments of the inventive concept one or more MRACs and/or interconnected MRACs may be provided to improve the predictability of the measured and/or quantified level of the energy efficiency of one or more homes for various points in times and/or for specified time periods.

Some embodiments of the inventive concept involve one or more MRACs and/or interconnected MRACs for the purpose of quantifying the level of the energy efficiency of one or more homes as a function of the cost of electric power or electric energy supplied in whole or in part by a local electric utility, or by other energy sources, such as stand-alone generators, wind or solar, at times in combination with local storage in batteries, for various points in times and/or for specified time periods.

Some embodiments of the inventive concept involve one or more MRACs and/or interconnected MRACs to calculate the cost of electric power and electric energy consumed to achieve and/or maintain specified levels of temperature, relative humidity, indoor air quality, and/or thermal comfort in one or more buildings, or in some parts of these homes, using one or more embodiments of this inventive concept.

Some embodiments of the inventive concept involve one or more MRACs and/or interconnected MRACs to calculate the cost of electric power and electric energy consumed to achieve and/or maintain specified levels of temperature, relative humidity, indoor air quality, and/or thermal comfort in these buildings, or in some parts of one or more homes, for specified points in times and/or for specified time periods.

Some embodiments of the inventive concept involve one or more MRACs and/or interconnected MRACs to achieve and/or maintain specified levels of temperature, relative humidity, indoor air quality, and/or thermal comfort in these homes, or in some parts of one or more buildings, for a specified cost level and/or range of costs of electric power or electric energy for various points in times and/or for specified time periods.

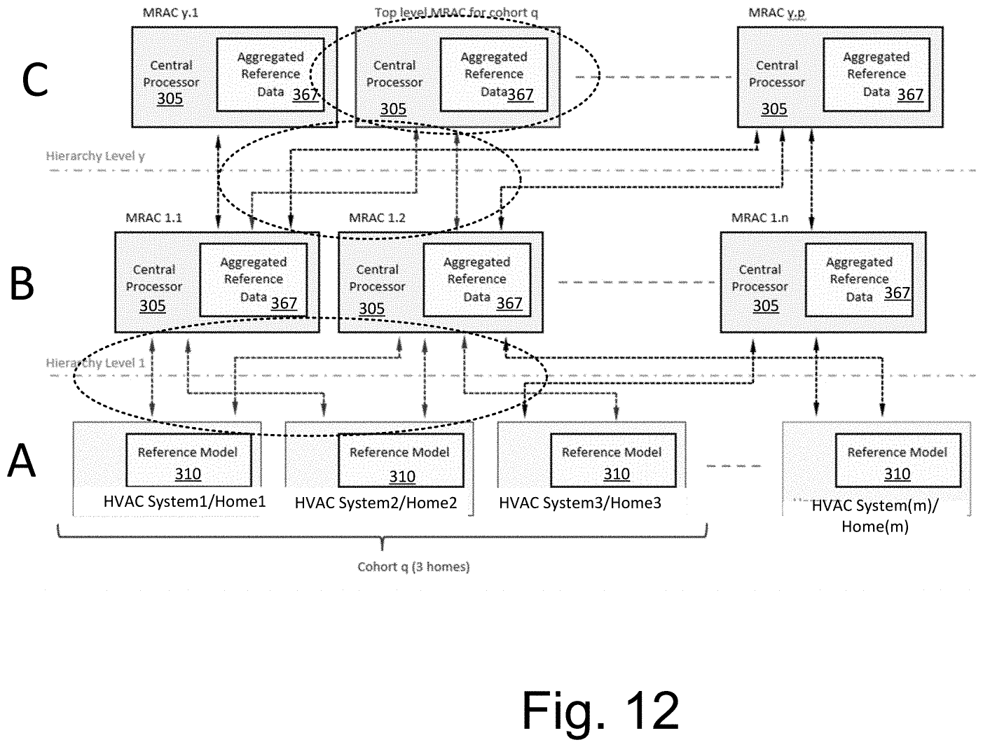

Some embodiments of the inventive concept involve one or more MRACs and/or interconnected MRACs to control the energy efficiency in a cohort, discussed above, with a growing number of homes included in one cohort. The accuracy of the measurement of the energy efficiency of one or more large cohorts may be increased by subdividing the one or more cohorts into subordinated cohorts in such a way that each of these subordinated cohorts contains homes with a greater similarity of the physical properties of their building or other constructive elements. The structure of the interconnecting network between MRACs may then be adjusted accordingly, and may or may not result in additional links between MRACs and/or another layer in the hierarchy of MRACs, and/or in an additional number of cohorts and associated MRACs at the same hierarchy level. An example of these embodiments is illustrated, for example, in FIG. 12.

As illustrated in FIG. 12, a cohort (cohort q) including three homes (Home 1, Home 2 and Home 3) is provided. Each of Home 1 and Home 2 communicate with MRACs 1.1 and 1.2 in the first level of hierarchy B, but Home 3 only communicated with MRAC 1.2 in the first level of hierarchy B. However, as further illustrated, Both MRAC 1.1 and 1.2 communicate with MRAC y.2 in the Y level of Hierarchy C, which in this embodiment represents the top level MRAC for Cohort q. Thus, the data from Home 3 is included at the top level. It will be understood the categories for subordination may be customized based on the information needed.

For example, in some embodiments, the one or more cohorts may be subordinated in such a way that each of these subordinated cohorts contains homes that are all co-located in a more narrowly defined “microclimate.” As used herein, a “microclimate” refers to the climate of a very small or restricted area, especially when this differs from the climate of the surrounding area. In these embodiments, the structure of the interconnecting network between MRACs may be adjusted accordingly, and may or may not result in another layer in the hierarchy of MRACs, and/or in an additional number of cohorts and associated MRACs at the same hierarchy level.

Some embodiments of the inventive concept may involve one or more MRACs and/or interconnected MRACs to control the energy efficiency in a cohort with a growing number of HVAC systems/homes included in this one cohort. The accuracy of the measurement of the energy efficiency of one or more cohorts may be increased by subdividing this one or more cohorts into subordinated cohorts in such a way that each of these subordinated cohorts contains homes that all have similar levels of thermal comfort. The structure of the interconnecting network between MRACs is then adjusted accordingly, and may or may not result in another layer in the hierarchy of MRACs, and/or in an additional number of cohorts and associated MRACs at the same hierarchy level.

Some embodiments of the inventive concept involve one or more MRACs and/or interconnected MRACs to control the energy efficiency in a cohort with a growing number of HVAC systems/homes included in this one cohort. The accuracy of the measurement of the energy efficiency of one or more cohorts may be increased by subdividing this one or more cohorts into subordinated cohorts in such a way that each of these subordinated cohorts contains homes that all have similar levels of indoor air quality. The structure of the interconnecting network between MRACs is then adjusted accordingly, and may or may not result in another layer in the hierarchy of MRACs, and/or in an additional number of cohorts and associated MRACs at the same hierarchy level.

Some embodiments of the inventive concept involve one or more MRACs and/or interconnected MRACs to control the energy efficiency in a cohort with a growing number of HVAC systems/homes included in this one cohort. The accuracy of the measurement of the energy efficiency of one or more cohorts may be increased by subdividing this one or more cohorts into subordinated cohorts in such a way that each of these subordinated cohorts contains homes that all have similar levels of ventilation with outside air. The structure of the interconnecting network between MRACs is then adjusted accordingly, and may or may not result in another layer in the hierarchy of MRACs, and/or in an additional number of cohorts and associated MRACs at the same hierarchy level.

Some embodiments of the inventive concept involve one or more MRACs and/or interconnected MRACs to control the energy efficiency in a cohort with a growing number of HVAC systems/homes included in this one cohort. The accuracy of the measurement of the energy efficiency of one or more cohorts may be increased by subdividing this one or more cohorts into subordinated cohorts in such a way that each of these subordinated cohorts contains homes that all have similar levels of the amount of make-up air required to maintain a positive pressurization of the building envelope under various levels of stack effect and/or wind speed and/or wind direction. The structure of the interconnecting network between MRACs is then adjusted accordingly, and may or may not result in another layer in the hierarchy of MRACs, and/or in an additional number of cohorts and associated MRACs at the same hierarchy level.

Some embodiments of the inventive concept involve one or more MRACs and/or interconnected MRACs to control the energy efficiency in a cohort with a growing number of HVAC systems/homes included in this one cohort. The accuracy of the measurement of the energy efficiency of one or more cohorts may be increased by subdividing this one or more cohorts into subordinated cohorts in such a way that each of these subordinated cohorts contains homes that all have occupants with similar socio-demographics, such as age, income, education, marital status, number and/or age of children, number and/or age of live-in relatives or domestic help, work-from-home status of one or more family members. The structure of the interconnecting network between MRACs is then adjusted accordingly, and may or may not result in another layer in the hierarchy of MRACs, and/or in an additional number of cohorts and associated MRACs at the same hierarchy level.

Some embodiments of the inventive concept involve one or more MRACs and/or interconnected MRACs to control the energy efficiency in a cohort with a given number of HVAC systems/homes included in this one cohort. The accuracy of the measurement of the energy efficiency of one or more cohorts may be increased by longitudinal analysis of the time series of one or more of the observed parameters, as shown but not limited to those listed above. The structure of the interconnecting network between MRACs may then be adjusted accordingly.

Some embodiments of the inventive concept involve one or more MRACs and/or interconnected MRACs to control the energy efficiency in a cohort with a given number of HVAC systems homes included in this one cohort. The accuracy of the measurement of the energy efficiency of one or more cohorts may be increased by longitudinal analysis of the time series of one or more of the observed parameters, as shown but not limited to those listed above. One of the outcomes of such a longitudinal analysis may be, but is not limited to the modification of a reference model incorporated in one or more MRACs (“adaptation”), and the structure of the interconnecting network between MRACs may then be adjusted accordingly.

Some embodiments of this inventive concept involve one or more MRACs and/or interconnected MRACs to control the energy efficiency in a cohort with a given number of HVAC systems/homes included in this one cohort. The accuracy of the measurement of the energy efficiency of one or more cohorts, and/or the ability to detect modified or manipulated sensed data, may be increased by longitudinal analysis of the time series of one or more of the observed parameters, as shown but not limited to those listed above. One of the methods used in such a longitudinal analysis may be, but is not limited to, the correlation between time series of one or more of the observed parameters, and may result in the modification of a reference model incorporated in one or more MRACs (“adaptation”), and the structure of the interconnecting network between MRACs may then be adjusted accordingly.

Some embodiments of this inventive concept involve one or more MRACs and/or interconnected MRACs to control the energy efficiency in a cohort with a given number of HVAC systems/homes included in this one cohort. The accuracy of the measurement of the energy efficiency of one or more cohorts, and/or the ability to detect modified or manipulated sensed data, may be increased by longitudinal analysis of the time series of one or more of the observed parameters, as shown but not limited to those listed above. One of the methods used in such a longitudinal analysis may be, but is not limited to the calculation of first, second or higher order derivatives and/or the momentum of the time series of one or more of the observed parameters, and may result in the adaptation of a reference model incorporated in one or more MRACs, and the structure of the interconnecting network between MRACs may then be adjusted accordingly.

Some embodiments of the inventive concept involve one or more MRACs and/or interconnected MRACs to control the energy efficiency in a cohort with a given number of HVAC systems/homes included in this one cohort. The accuracy of the measurement of the energy efficiency of one or more cohorts, and/or the ability to detect modified or manipulated sensed data, may be increased by longitudinal analysis of one or more output parameters of one or more of the interconnected MRACs. One of the methods used in such a longitudinal analysis may be, but is not limited to the calculation of first, second or higher order derivatives and/or the momentum of the time series of one or more of the derived parameters, and may result in the adaptation of a reference model incorporated in one or more MRACs, and the structure of the interconnecting network between MRACs may then be adjusted accordingly.

Some embodiments of the inventive concept involve one or more MRACs either separately or in combination that can use the parameters of the HVAC system discussed above to provide model reference data for the calculation of highly accurate predictive system capacity values.

Some embodiments of the inventive concept involve one or more MRACs either separately or in combination that provide highly accurate predictive reference data for the purpose of comparing them with the measured system capacity of a particular HVAC system, and to facilitate the detection of a discrepancy between the predictive value provided by the MRACs and the measured system capacity value for a particular HVAC system while it is operating under any one of the specific parameters of the HVAC system discussed above.

Some embodiments of the inventive concept involve the determination of the temporal and/or spatial distribution of heating and/or cooling loads for one or more buildings, and/or the system capacity of one or more HVAC systems installed in the one or more buildings that have a variety of distinctly different physical properties as set out above.

Some embodiments of the inventive concept involve one or more MRACs and/or interconnected MRACs for the purpose of quantifying the EER of one or more HVAC systems as a function of the level of energy efficiency of one or more buildings for various points in times and/or for specified time periods.

Some embodiments of the inventive concept involve one or more MRACs and/or interconnected MRACs for the purpose of improving the accuracy of quantifying the EER of one or more HVAC systems as a function of energy efficiency of one or more buildings.

Some embodiments of the inventive concept involve one or more MRACs and/or interconnected MRACs for the purpose of verifying the variability of the quantification of the EER of one or more HVAC systems as a function of the level of energy efficiency of one or more buildings for various points in times and/or for specified time periods.

Some embodiments of the inventive concept involve one or more MRACs and/or interconnected MRACs for the purpose of improving the predictability of quantifying the EER of one or more HVAC systems as a function of the measured and/or quantified level of the energy efficiency of one or more buildings for various points in times and/or for specified time periods.

Some embodiments of the inventive concept involve one or more MRACs and/or interconnected MRACs for the purpose of quantifying the EER of one or more HVAC systems as a function of the cost of electric power or electric energy supplied in whole or in part by a local electric utility, or by other energy sources, such as stand-alone generators, wind or solar, at times in combination with local storage in batteries, for various points in times and/or for specified time periods.

Some embodiments of the inventive concept involve one or more MRACs and/or interconnected MRACs to calculate the cost of electric power and electric energy consumed by one or more HVAC systems to achieve and/or maintain specified levels of temperature, relative humidity, indoor air quality, and/or thermal comfort in one or more buildings, or in some parts of one or more buildings, using one or more embodiments of this inventive concept.

Some embodiments of the inventive concept involve one or more MRACs and/or interconnected MRACs to calculate the cost of electric power and electric energy consumed by one or more HVAC systems to achieve and/or maintain specified levels of temperature, relative humidity, indoor air quality, and/or thermal comfort in one or more buildings, or in some parts of one or more buildings, for specified points in time and/or for specified time periods.

Some embodiments of the inventive concept involve one or more MRACs and/or interconnected MRACs to calculate the cost of electric power and electric energy consumed by one or more HVAC systems to achieve and/or maintain specified levels of temperature, relative humidity, indoor air quality, and/or thermal comfort in these buildings, or in some parts of one or more buildings, for a specified cost level and/or range of costs of electric power or electric energy for various points in time and/or for specified time periods.

Some embodiments of the inventive concept involve one or more MRACs and/or interconnected MRACs to increase the accuracy of quantifying the EER of one or more HVAC systems as a function of the energy efficiency of the building envelopes of a group of buildings (“cohort”) that have one or more similar physical properties as discussed above.

Some embodiments of the inventive concept involve one or more MRACs and/or interconnected MRACs to quantify the EER of one or more HVAC systems in a cohort with a growing number of buildings included in this one cohort. The accuracy of the measurement of the EER of one or more HVAC systems in one or more cohorts may be increased by subdividing this one or more cohorts into subordinated cohorts in such a way that each of these subordinated cohorts contains buildings with a greater similarity of the physical properties of their building envelopes. The structure of the interconnecting network between MRACs may then be adjusted accordingly, and may or may not result in additional links between MRACs and/or another layer in the hierarchy of MRACs, and/or in an additional number of cohorts and associated MRACs at the same hierarchy level.

Some embodiments of the inventive concept involve one or more MRACs and/or interconnected MRACs to control the EER of one or more HVAC systems in a cohort with a growing number of buildings included in this one cohort. The accuracy of the measurement of the EER of one or more HVAC systems in one or more cohorts may be increased by subdividing this one or more cohorts into subordinated cohorts in such a way that each of these subordinated cohorts contains buildings that are all co-located in a more narrowly defined microclimate. The structure of the interconnecting network between MRACs may then be adjusted accordingly, and may or may not result in another layer in the hierarchy of MRACs, and/or in an additional number of cohorts and associated MRACs at the same hierarchy level.

Some embodiments of the inventive concept involve one or more MRACs and/or interconnected MRACs to control the EER of one or more HVAC systems in a cohort with a growing number of buildings included in this one cohort. The accuracy of the measurement of EER of one or more HVAC systems one or more cohorts may be increased by subdividing this one or more cohorts into subordinated cohorts in such a way that each of these subordinated cohorts contains buildings that all have similar levels of thermal comfort. The structure of the interconnecting network between MRACs is then adjusted accordingly, and may or may not result in another layer in the hierarchy of MRACs, and/or in an additional number of cohorts and associated MRACs at the same hierarchy level.

Some embodiments of the inventive concept involve one or more MRACs and/or interconnected MRACs to control the EER of one or more HVAC systems in a cohort with a growing number of buildings included in this one cohort. The accuracy of the measurement of EER of one or more HVAC systems one or more cohorts may be increased by subdividing this one or more cohorts into subordinated cohorts in such a way that each of these subordinated cohorts contains buildings that all have similar levels of indoor air quality. The structure of the interconnecting network between MRACs is then adjusted accordingly, and may or may not result in another layer in the hierarchy of MRACs, and/or in an additional number of cohorts and associated MRACs at the same hierarchy level.

Some embodiments of the inventive concept involve one or more MRACs and/or interconnected MRACs to control the EER of one or more HVAC systems in a cohort with a growing number of buildings included in this one cohort. The accuracy of the measurement of EER of one or more HVAC systems one or more cohorts may be increased by subdividing this one or more cohorts into subordinated cohorts in such a way that each of these subordinated cohorts contains buildings that all have similar levels of ventilation with outside air. The structure of the interconnecting network between MRACs is then adjusted accordingly, and may or may not result in another layer in the hierarchy of MRACs, and/or in an additional number of cohorts and associated MRACs at the same hierarchy level.

Some embodiments of the inventive concept involve one or more MRACs and/or interconnected MRACs to control the EER of one or more HVAC systems in a cohort with a growing number of buildings included in this one cohort. The accuracy of the measurement of EER of one or more HVAC systems one or more cohorts may be increased by subdividing this one or more cohorts into subordinated cohorts in such a way that each of these subordinated cohorts contains buildings that all have similar levels of the amount of make-up air required to maintain a positive pressurization of the building envelope under various levels of stack effect and/or wind speed and/or wind direction. The structure of the interconnecting network between MRACs is then adjusted accordingly, and may or may not result in another layer in the hierarchy of MRACs, and/or in an additional number of cohorts and associated MRACs at the same hierarchy level.

Some embodiments of the inventive concept involve one or more MRACs and/or interconnected MRACs to control the EER of one or more HVAC systems in a cohort with a growing number of buildings included in this one cohort. The accuracy of the measurement of EER of one or more HVAC systems one or more cohorts may be increased by subdividing this one or more cohorts into subordinated cohorts in such a way that each of these subordinated cohorts contains buildings that all have similar socio-demographics, such as age, income, education, marital status, number and/or age of children, number and/or age of live-in relatives or domestic help, work-from-home status of one or more family members. The structure of the interconnecting network between MRACs is then adjusted accordingly, and may or may not result in another layer in the hierarchy of MRACs, and/or in an additional number of cohorts and associated MRACs at the same hierarchy level.

Some embodiments of the inventive concept involve one or more MRACs and/or interconnected MRACs to control the EER of one or more HVAC systems in subordinated cohorts in such a way that the adaptive control process in each of these subordinated cohorts has its own, localized reference model (“M”) that is now highly descriptive of the particular circumstances as discussed above.

Some embodiments of the inventive concept involve one or more MRACs and/or interconnected MRACs to control the EER of one or more HVAC systems in a cohort with a given number of buildings included in this one cohort. The accuracy of the measurement of EER of one or more HVAC systems in one or more cohorts may be increased by longitudinal analysis of the time series of one or more of the observed parameters, as shown but not limited to those discussed above. The structure of the interconnecting network between MRACs may then be adjusted accordingly.

Some embodiments of the inventive concept involve one or more MRACs and/or interconnected MRACs to control the EER of one or more HVAC systems in a cohort with a given number of buildings included in this one cohort. The accuracy of the measurement of EER of one or more HVAC systems in one or more cohorts may be increased by longitudinal analysis of the time series of one or more of the observed parameters, as discussed above. One of the outcomes of such a longitudinal analysis may be, but is not limited to, the modification of a reference model incorporated in one or more MRACs (“adaptation”), and the structure of the interconnecting network between MRACs may then be adjusted accordingly.

Some embodiments of this inventive concept involve one or more MRACs and/or interconnected MRACs to control EER of one or more HVAC systems in a cohort with a given number of buildings included in this one cohort. The accuracy of the measurement of EER of one or more HVAC systems in one or more cohorts may be increased by longitudinal analysis of the time series of one or more of the observed parameters. One of the methods used in such a longitudinal analysis may be, but is not limited to, the correlation between time series of one or more of the observed parameters, and may result in the modification of a reference model incorporated in one or more MRACs (“adaptation”), and the structure of the interconnecting network between MRACs may then be adjusted accordingly.

Some embodiments of this inventive concept involve one or more MRACs and/or interconnected MRACs to control EER of one or more HVAC systems in a cohort with a given number of buildings included in this one cohort. The accuracy of the measurement of EER of one or more HVAC systems in one or more cohorts may be increased by longitudinal analysis of the time series of one or more of the observed parameters. One of the methods used in such a longitudinal analysis may be, but is not limited to the calculation of first, second or higher order derivatives and/or the momentum of the time series of one or more of the observed parameters, and may result in the adaptation of a reference model incorporated in one or more MRACs, and the structure of the interconnecting network between MRACs may then be adjusted accordingly.

Some embodiments of this inventive concept involve one or more MRACs and/or interconnected MRACs to control EER of one or more HVAC systems in a cohort with a given number of buildings included in this one cohort. The accuracy of the measurement of EER of one or more HVAC systems in one or more cohorts may be increased by longitudinal analysis of the time series of one or more of the observed parameters. One of the methods used in such a longitudinal analysis may be, but is not limited to the calculation of first, second or higher order derivatives and/or the momentum of the time series of one or more of the derived parameters, and may result in the adaptation of a reference model incorporated in one or more MRACs, and the structure of the interconnecting network between MRACs may then be adjusted accordingly.

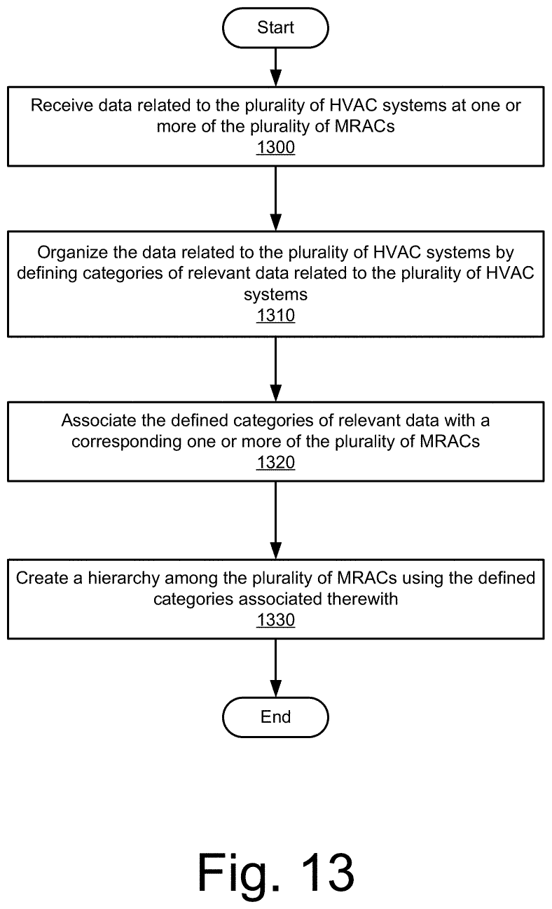

Operations according to some embodiments of the present inventive concept will be discussed with respect to the flowchart of FIG. 13. As illustrated in FIG. 13, operations for assessing energy efficiency of a building in a system including a plurality of model reference adaptive controllers (MRACs) in communication with a plurality of local reference models positioned at one of each of a corresponding plurality of HVAC systems in buildings begin at block 1300 by receiving data related to the plurality of HVAC systems at one or more of the plurality of MRACs. As discussed above, local buildings or homes include a dedicated reference model that represents data about the building performance. This data from each HVAC system/building/home is shared with the MRACs/central processor. As discussed above, the data related to the plurality of HVAC systems may be associated with, but is not limited to, physical properties of the building, a location of the building, an operational status of the building, a geographic orientation of the building, an elevation of the building, performance of a building envelope, occupants of the building and/or climate inside or outside the building. A more detailed list of examples of this data is provided above.

The data related to the plurality of HVAC systems is organized by defining categories of relevant data related to the plurality of buildings (block 1310). As discussed above, a category may include a list of physical properties of the home/building. For example, one story homes, having heat pumps, less than 2000 square feet, located in Arizona. This is only provided as an example, the categories of relevant data may be defined by, but is not limited to, one or more of the physical properties of the building, its operational status, the location of the building, the orientation of the building, the occupants of the building and/or the climate inside or outside the building.

The defined categories of relevant data are associated with a corresponding one or more of the plurality of MRACs, each of the plurality of MRACs receiving data related to the plurality of buildings that satisfy data in the defined categories associated therewith (block 1320). For example, FIG. 11 shows various MRACs received data from different homes or cohorts of homes.

A hierarchy is created among the plurality of MRACs using the defined categories associated therewith (block 1330) such that each increasing level of the hierarchy provides a more detailed assessment of energy efficiency for the HVAC system in the buildings in the defined category of relevant data associated with each particular one of the plurality of MRACs. The details of hierarchies and how they are used in accordance with embodiments of the present inventive concept are discussed above.

In some embodiments, the received data related to the plurality of HVAC systems in buildings within each of the defined categories may be evaluated and thresholds may be defined based on the evaluated data. The thresholds may indicate consistent values for the data based on the received data from the plurality of HVAC systems in buildings. In other words, the thresholds define what is normal for HVAC systems in this category—i.e. HVAC systems having similar performance properties. HVAC systems are identified among the plurality of buildings providing data that falls outside the defined thresholds and causation for the lack of compliance at the—HVAC systems, such as, but not limited to, deliberate tampering of the sensed data, or any other kind of interference by a third party of the data sensing process, for example, may be determined.

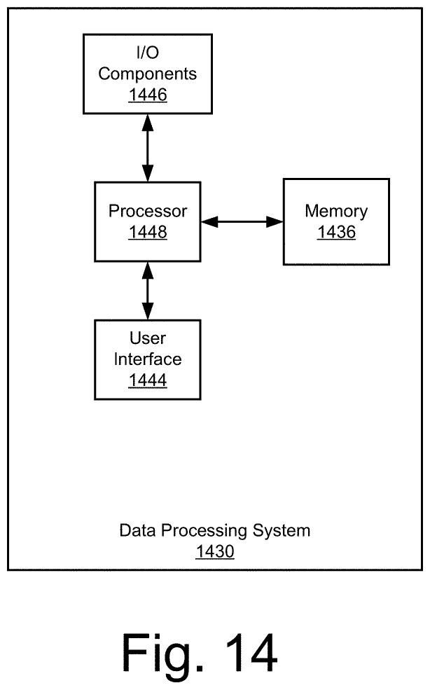

As discussed above, in some embodiments, the two or more HVAC systems in buildings of the plurality of HVAC systems in buildings may be grouped to define one or more cohorts of HVAC systems where each of the cohorts includes two or more HVAC systems that have one or more similar physical properties. It will be understood that as is clear from the details of the present inventive concept, embodiments of the present inventive concept require data processing. Referring now to FIG. 14, an example of a data processing system 1430 suitable for use with any of the examples described above will be discussed. The data processing system 1430 may be part of any component of the system without departing from the scope of the present inventive concept. In some examples, the data processing system 1430 can be any suitable computing device for performing operations according to the embodiments discussed herein described herein.

As illustrated, the data processing system 1430 includes a processor 1448 communicatively coupled to I/O components 1446, a user interface 1444 and a memory 1436. The processor 1448 can include one or more commercially available processors, embedded processors, secure processors, microprocessors, dual microprocessors, multi-core processors, other multi-processor architectures, another suitable processing device, or any combination of these. The memory 1436, which can be any suitable tangible (and non-transitory) computer-readable medium such as random access memory (RAM), read-only memory (ROM), erasable and electronically programmable read-only memory (EEPROMs), or the like, embodies program components that configure operation of the data processing system 1430.

I/O components 1446 may be used to facilitate wired or wireless connections to devices such as one or more displays, game controllers, keyboards, mice, joysticks, cameras, buttons, speakers, microphones and/or other hardware used to input or output data. Memory 636 represents nonvolatile storages such as magnetic, optical, or other storage media included in the data processing system and/or coupled to processor 1448.

The user interface 1444 may include, for example, a keyboard, keypad, touchpad, voice activation circuit, display or the like and the processor 1448 may execute program code or instructions stored in memory 1436.

It should be appreciated that data processing system 1430 may also include additional processors, additional storage, and a computer-readable medium (not shown). The processor(s) 648 may execute additional computer-executable program instructions stored in memory 1436. Such processors may include a microprocessor, digital signal processor, application-specific integrated circuit, field programmable gate arrays, programmable interrupt controllers, programmable logic devices, programmable read-only memories, electronically programmable read-only memories, or other similar devices.

The aforementioned flow logic and/or methods show the functionality and operation of various services and applications described herein. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor in a computer system or other system. The machine code may be converted from the source code, etc. Other suitable types of code include compiled code, interpreted code, executable code, static code, dynamic code, object-oriented code, visual code, and the like. The examples are not limited in this context.

If embodied in hardware, each block may represent a circuit or a number of interconnected circuits to implement the specified logical function(s). A circuit can include any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xeon®, Atom® and XScale® processors; and similar processors. Other types of multi-core processors and other multi-processor architectures may also be employed as part of the circuitry. According to some examples, circuitry may also include an application specific integrated circuit (ASIC) or a field programmable gate array (FPGA), and modules may be implemented as hardware elements of the ASIC or the FPGA. Further, embodiments may be provided in the form of a chip, chipset or package.

Although the aforementioned flow logic and/or methods each show a specific order of execution, it is understood that the order of execution may differ from that which is depicted. Also, operations shown in succession in the flowcharts may be able to be executed concurrently or with partial concurrence. Further, in some embodiments, one or more of the operations may be skipped or omitted. In addition, any number of counters, state variables, warning semaphores, or messages might be added to the logical flows or methods described herein, for purposes of enhanced utility, accounting, performance measurement, or providing troubleshooting aids, etc. It is understood that all such variations are within the scope of the present disclosure. Moreover, not all operations illustrated in a flow logic or method may be required for a novel implementation.

Where any operation or component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages. Software components are stored in a memory and are executable by a processor. In this respect, the term “executable” means a program file that is in a form that can ultimately be run by a processor. Examples of executable programs may be, for example, a compiled program that can be translated into machine code in a format that can be loaded into a random access portion of a memory and run by a processor, source code that may be expressed in proper format such as object code that is capable of being loaded into a random access portion of a memory and executed by a processor, or source code that may be interpreted by another executable program to generate instructions in a random access portion of a memory to be executed by a processor, etc. An executable program may be stored in any portion or component of a memory. In the context of the present disclosure, a “computer-readable medium” can be any medium (e.g., memory) that can contain, store, or maintain the logic or application described herein for use by or in connection with the instruction execution system.

A memory is defined herein as an article of manufacture and including volatile and/or non-volatile memory, removable and/or non-removable memory, erasable and/or non-erasable memory, writeable and/or re-writeable memory, and so forth. Volatile components are those that do not retain data values upon loss of power. Nonvolatile components are those that retain data upon a loss of power. Thus, a memory may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), or other like memory device.

The devices described herein may include multiple processors and multiple memories that operate in parallel processing circuits, respectively. In such a case, a local interface, such as a communication bus, may facilitate communication between any two of the multiple processors, between any processor and any of the memories, or between any two of the memories, etc. A local interface may include additional systems designed to coordinate this communication, including, for example, performing load balancing. A processor may be of electrical or of some other available construction.

It should be emphasized that the above-described embodiments of the present disclosure are merely possible examples of implementations set forth for a clear understanding of the principles of the disclosure. It is, of course, not possible to describe every conceivable combination of components and/or methodologies, but one of ordinary skill in the art may recognize that many further combinations and permutations are possible. That is, many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A method for assessing the energy efficiency of a heating, ventilation and air-conditioning (HVAC) system in a building in a system, the system including a plurality of model reference adaptive controllers (MRACs) in communication with a plurality of local reference models positioned at one of each of a corresponding plurality of HVAC systems, the method comprising:
receiving data related to the plurality of HVAC systems at one or more of the plurality of MRACs, wherein the data related to the plurality of HVAC systems is associated with physical, structural and/or thermal properties of a building associated with each of the plurality of HVAC systems, a location of the building, an operational status of the building, a geographic orientation of the building, an elevation of the building, performance of a building envelope, occupants of the building and/or climate inside or outside the building;
organizing the data related to the plurality of HVAC systems by defining categories of relevant data related to the plurality of HVAC systems, the categories of relevant data being defined by one or more of the properties of the building, the location of the building, the operational status of the building, the geographic orientation of the building, the elevation of the building, performance of a building envelope, the occupants of the building and/or the climate inside or outside the building;
associating the defined categories of relevant data with a corresponding one or more of the plurality of MRACs, each of the plurality of MRACs receiving data related to the plurality of HVAC systems that satisfy data in the defined categories associated therewith; and
creating a hierarchy among the plurality of MRACs using the defined categories associated therewith such that each increasing level of the hierarchy provides a more detailed assessment of energy efficiency for HVAC systems in the defined category of relevant data associated with each particular one of the plurality of MRACs,
wherein at least one of the receiving, organizing, associating and creating are performed by at least one processor.

2. The method of claim 1, further comprising:
evaluating received data related to the plurality of HVAC systems within each of the defined categories;
defining thresholds based on the evaluated data, the thresholds indicating consistent values for the data based on the received data from the plurality of HVAC systems; and
identifying HVAC systems among the plurality of HVAC systems providing data that falls outside the defined thresholds.

3. The method of claim 2, wherein identifying is followed by identifying causation at the HVAC systems identified as providing data that falls outside the defined threshold.

4. The method of claim 1, further comprising:
grouping two or more HVAC systems of the plurality of HVAC systems to define one or more cohorts of HVAC systems, wherein each of the cohorts includes two or more HVAC systems that have one or more similar physical and/or operational properties; and
wherein creating the hierarchy among the plurality of MRACs further comprises creating the hierarchy using the one or more cohorts.

5. The method of claim 4, wherein an HVAC system belongs to more than one cohort.

6. The method of claim 1, wherein the data associated with the one or more HVAC systems comprises a specific geographic location; an orientation of outside walls of the building home facing either north, south, or any number of degrees in between; a number of levels of the building; an attached or detached garage; details on pitches of roofs on various parts of the building; number, size and orientation of dormers; various degrees of roof overhang; various numbers, locations, and sizes of windows that have various levels of solar heat gain coefficients (“SHG”) and/or various levels of air leakage; various numbers, locations, and sizes of outside doors that have various levels of solar heat gain coefficients (“SHG”) and/or various levels of air leakage; entire sets or subsets of foundations consisting of concrete slabs, crawlspaces or full basements constructed with a range of building materials (“foundations”); entire sets or subsets of foundations, walls, ceilings, floors, attics, and roofs with different levels of thermal insulation; entire sets or subsets of foundations, walls, ceilings, floors, attics and roofs with different levels of infiltration; entire sets or subsets of foundations, walls, ceilings, floors, attics, and roofs with different levels of thermal insulation; and/or entire sets or subsets of walls, ceilings, floors, attics and roofs with different amounts of thermal mass; details with respect to occupants of the building.

7. At least one non-transitory machine-readable medium comprising a set of instructions executable on at least one computing device to cause the at least one computing device to assess energy efficiency of an HVAC system in a system, the system including a plurality of model reference adaptive controllers (MRACs) in communication with a plurality of local reference models positioned at one of each of a corresponding plurality of HVAC systems, the set of instructions to:
receive data related to the plurality of HVAC systems in buildings at one or more of the plurality of MRACs, wherein the data related to the plurality of HVAC systems is associated with physical properties of a building associated with each of the HVAC systems, a location of the building, an operational status of the building, a geographic orientation of the building, an elevation of the building, performance of a building envelope, occupants of the building and/or climate inside or outside the building;
organize the data related to the plurality of HVAC systems by defining categories of relevant data related to the plurality of HVAC systems, the categories of relevant data being defined by one or more of the physical properties of the building, the location of the building, the operational status of the building, the geographic orientation of the building, the elevation of the building, the performance of a building envelope, the occupants of the building and/or the climate inside or outside the building;
associate the defined categories of relevant data with a corresponding one or more of the plurality of MRACs, each of the plurality of MRACs receiving data related to the plurality of HVAC systems that satisfy data in the defined categories associated therewith; and
create a hierarchy among the plurality of MRACs using the defined categories associated therewith such that each increasing level of the hierarchy provides a more detailed assessment of energy efficiency for HVAC systems in the defined category of relevant data associated with each particular one of the plurality of MRACs.

8. The non-transitory machine-readable medium of claim 7, the set of instructions executable on the at least one computing device to further:
evaluate received data related to the plurality of HVAC systems within each of the defined categories;
define thresholds based on the evaluated data, the thresholds indicating consistent values for the data based on the received data from the plurality of HVAC systems; and
identify buildings among the plurality of HVAC systems providing data that falls outside the defined thresholds.

9. The non-transitory machine-readable medium of claim 8, the set of instructions executable on the at least one computing device to identify causation at the buildings identified as providing data that falls outside the defined threshold.

10. The non-transitory machine-readable medium of claim 7, the set of instructions executable on the at least one computing device to further:
group two or more buildings of the plurality of HVAC systems to define one or more cohorts of buildings, wherein each of the cohorts includes two or more buildings that have one or more similar physical properties; and
wherein the set of instructions to create the hierarchy among the plurality of MRACs further comprises a set of instructions to create the hierarchy using the one or more cohorts.

11. The non-transitory machine-machine readable medium of claim 10, wherein a building belongs to more than one cohort.

12. The non-transitory machine-machine readable medium of claim 7, wherein the data associated with the one or more buildings comprises a specific geographic location; an orientation of outside walls of the building home facing either north, south, or any number of degrees in between; a number of levels of the building; an attached or detached garage; details on pitches of roofs on various parts of the building; number, size and orientation of dormers; various degrees of roof overhang; various numbers, locations, and sizes of windows that have various levels of solar heat gain coefficients (“SHG”) and/or various levels of air leakage; various numbers, locations, and sizes of outside doors that have various levels of solar heat gain coefficients (“SHG”) and/or various levels of air leakage; entire sets or subsets of foundations consisting of concrete slabs, crawlspaces or full basements constructed with a range of building materials (“foundations”); entire sets or subsets of foundations, walls, ceilings, floors, attics, and roofs with different levels of thermal insulation; entire sets or subsets of foundations, walls, ceilings, floors, attics and roofs with different levels of infiltration; entire sets or subsets of foundations, walls, ceilings, floors, attics, and roofs with different levels of thermal insulation; and/or entire sets or subsets of walls, ceilings, floors, attics and roofs with different amounts of thermal mass; details with respect to occupants of the building.

13. A computer for assessing energy efficiency of an HVAC system in a system, the system including a plurality of model reference adaptive controllers (MRACs) in communication with a plurality of local reference models positioned at one of each of a corresponding plurality of HVAC systems, comprising:
one or more processors; and
a non-transitory computer readable medium to store a set of instructions executable by the one or more processors, the set of instructions to cause the one or more processors to:
receive data related to the plurality of HVAC systems at one or more of the plurality of MRACs, wherein the data related to the plurality of HVAC systems is associated with physical properties of a building associated with one of the plurality of HVAC systems, a location of the building, an operational status of the building, a geographic orientation of the building, an elevation of the building, performance of a building envelope, occupants of the building and/or climate inside or outside the building;
organize the data related to the plurality of HVAC systems by defining categories of relevant data related to the plurality of HVAC systems, the categories of relevant data being defined by one or more of the physical properties of the building, the location of the building, the operational status of the building, the geographic orientation of the building, the elevation of the building, performance of a building envelope, the occupants of the building and/or the climate inside or outside the building;
associate the defined categories of relevant data with a corresponding one or more of the plurality of MRACs, each of the plurality of MRACs receiving data related to the plurality of HVAC systems that satisfy data in the defined categories associated therewith; and
create a hierarchy among the plurality of MRACs using the defined categories associated therewith such that each increasing level of the hierarchy provides a more detailed assessment of energy efficiency for buildings in the defined category of relevant data associated with each particular one of the plurality of MRACs.

14. The computer of claim 13, the set of instructions to cause the one or more processors to further:
evaluate received data related to the plurality of HVAC systems within each of the defined categories;
define thresholds based on the evaluated data, the thresholds indicating consistent values for the data based on the received data from the plurality of HVAC systems; and
identify buildings among the plurality of HVAC systems providing data that falls outside the defined thresholds.

15. The computer of claim 14, the set of instructions to cause the one or more processors to further identify causation at the buildings identified as providing data that falls outside the defined threshold.

16. The computer of claim 13, the set of instructions to cause the one or more processors to further:
group two or more buildings of the plurality of HVAC systems to define one or more cohorts of buildings, wherein each of the cohorts includes two or more buildings that have one or more similar physical properties; and
wherein the set of instructions to create the hierarchy among the plurality of MRACs further comprises a set of instructions to create the hierarchy using the one or more cohorts.

17. The computer of claim 16, wherein a building belongs to more than one cohort.

18. The computer of claim 13, wherein the data associated with the one or more buildings comprises a specific geographic location; an orientation of outside walls of the building home facing either north, south, or any number of degrees in between; a number of levels of the building; an attached or detached garage; details on pitches of roofs on various parts of the building; number, size and orientation of dormers; various degrees of roof overhang; various numbers, locations, and sizes of windows that have various levels of solar heat gain coefficients (“SHG”) and/or various levels of air leakage; various numbers, locations, and sizes of outside doors that have various levels of solar heat gain coefficients (“SHG”) and/or various levels of air leakage; entire sets or subsets of foundations consisting of concrete slabs, crawlspaces or full basements constructed with a range of building materials (“foundations”); entire sets or subsets of foundations, walls, ceilings, floors, attics, and roofs with different levels of thermal insulation; entire sets or subsets of foundations, walls, ceilings, floors, attics and roofs with different levels of infiltration; entire sets or subsets of foundations, walls, ceilings, floors, attics, and roofs with different levels of thermal insulation; and/or entire sets or subsets of walls, ceilings, floors, attics and roofs with different amounts of thermal mass; details with respect to occupants of the building.
